(19) United States
(12) Patent Application Publication
(10) Pub. No.: US 2010/0220315 A1
(43) Pub. Date: Sep. 2, 2010

(54) Stabilized Optical System for Flow Cytometry

(75) Inventors: Michael M. Morrell, Wellington, CO (US); Neil R. Van Lieu, Fort Collins, CO (US)

Correspondence Address: STERNE KESSLER GOLDSTEIN & FOX, P.L.L.C., 1100 NEW YORK AVENUE, N.W., WASHINGTON, DC, 20005, US

(73) Assignee: Beckman Coulter, Inc.

(21) Appl. No.: 12/710,100

(22) Filed: Feb. 22, 2010

Related U.S. Application Data
(60) Provisional application No. 61/156,306, filed on Feb. 27, 2009.

(51) Int. Cl. G01N 21/00

(52) U.S. Cl. 356/73

(57) ABSTRACT

A particle analyzer that includes optical waveguides, a support, and a detector. The optical waveguides direct spatially separated beams from a source of radiation to produce measuring beams in a sample flow measuring area. The support maintains each of the optical waveguides in a fixed relative position with respect to each other and maintains the positioning of the measuring beams within the measuring area. The detector senses light produced from the measuring beams interacting with a particle flowing through the measuring area. At least one of the support and the detector can be coupled to the core stream sample system. The coupling can use an optical waveguide device configured to convey optical radiation arising from sample interaction to the detector. In another example, a particle analyzer comprises an optical system configured to be fixedly coupled to a sample system and configured to direct beams along independent beam paths from a source of radiation to produce measuring beam spots in a sample flow measuring area of the sample system and a detection system configured to sense radiation delivered from the sample flow measuring area.

### CROSS-REFERENCE TO RELATED APPLICATIONS

This application claims the benefit under 35 U.S.C. §119(e) of U.S. Provisional Application No. 61/156,306, filed Feb. 27, 2009, which is incorporated by reference herein in its entirety.

### BACKGROUND

1. Field of the Invention

The present invention generally relates to particle analyzers, and particularly to flow cytometers wherein the optical system is stabilized to minimize changes in measurement performance over time.

2. Related Art

In flow cytometry, a flow cytometer instrument lines up particles, such as cells, into a single line from a plurality of particles. The line, or sample stream, of cells passes through a beam of radiation formed by a light source, such as a laser beam. The flow cytometer instrument captures light that emerges, emits, or scatters from interaction(s) with each of the plurality of cells as each cell passes through the beam of radiation.

The emitted light is e.g., spectrally separated, such as through the use of optical filters, and directed to a number of light detectors, where each filter and detector combination is specific to the wavelength bands or regions of interest. Electrical signals, such as pulses, produced by a detector, can be processed, using various methods, to allow the analytical grouping and discrimination of the substance under study.

Due to the unique spectral characteristics of many fluorochromes used in flow cytometry, and for particular phenotypic analysis of biological cells, it is often necessary to employ one or more excitation or light sources. To utilize multiple light sources, such as lasers, within a flow cytometer e.g., involves manufacturing, adding, or exchanging free-space optics, or optical fiber waveguides, or a combination of the free-space and fiber optics for each laser, in order to deliver the light to the sample measurement region. The multiple light sources are e.g., placed so as to have physical separation of the individual light beams along the sample stream, so that a given particle or cell is irradiated by each beam in a serial fashion as the particle flows along the path of the sample stream. The resulting emitted or scattered light is e.g., captured from each of these corresponding sample illumination locations by, for example, an objective lens, which then guides the spatially separated collected light to different sets of filters and detectors. Each of these filter and detector sets then characterizes the sample response to the irradiation from one of the multiple light sources.

The relative positioning can change over time between the light source, the optical elements that guide any excitation light source to the sample, the sample stream, the emitted or scattered light collection optics, and the detection system. This change can be due to thermal excursions in the materials that comprise the light source, the optics and mount of the excitation light delivery system, the fluorescence and scattered light collection systems, as well as the mounting of these systems relative to the sample stream system. Besides thermal instabilities, mechanical vibration, shock, and stresses might also adversely affect alignment of the excitation source, excitation delivery optics, sample stream, optical collection, and detection systems. This changing alignment between optical and mechanical components and systems, as well the core sample stream, changes the performance characteristics of the flow cytometer system.

In addition, the behavior of the sample stream of flowing particles e.g., varies over time. The sample stream can exhibit changes in fluidic properties, which affect the position or shape of the stream. The particles can also change position or the behavior of motion within the sample stream. These variations e.g., are due to changes in sample or ambient environmental changes, such as temperature or pressure, or they can be due to time varying tribological or other fluidic handling system properties, or the nature of the biological mixture fluid itself.

Therefore, what is needed are systems and methods to direct beams to irradiate a sample stream and collect the resulting emitted or scattered radiation in a manner that minimizes or eliminates relative motion between components of the system, and which are tolerant of changes in the sample stream behavior, in order to provide stable flow cytometer measurement performance over time.

### SUMMARY

According to an embodiment of the present invention, there is provided a particle analyzer that includes optical waveguides, a support, and a detector. The optical waveguides direct spatially separated beams from a source of radiation to produce measuring beams in a sample flow measuring area. The support maintains each of the optical waveguides in a fixed relative position with respect to each other and maintains the positioning of the measuring beams within the measuring area. The detector senses light produced from the measuring beams interacting with a particle flowing through the measuring area.

According to another embodiment of the present invention, there is provided a method of analyzing particles comprising the following steps (not necessarily in the order given). Preparing a fluid sample containing particles for analysis is a particle analyzer. Transmitting light from a source or radiation through optical waveguides. Directing the light from the optical waveguides as a multiple of spatially separated beams along a plane of a measurement region of the fluid sample. Sensing light produced through the interaction of the spatially separated beams with respective particles flowing through the measurement region, and analyzing the signal to determine a parameter of the respective particles.

According to a further embodiment of the present invention, there is provided a particle analyzer comprising an optical system configured to be fixedly coupled to a sample system and configured to direct beams along independent beam paths from a source of radiation to produce measuring beam spots in a sample flow measuring area of the sample system and a detection system configured to sense radiation delivered from the sample flow measuring area.

Further embodiments and features, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments of the invention will now be described, by way of example only, with reference to the accompanying drawings in which corresponding reference symbols indicate corresponding parts. Further, the accompanying drawings, which are incorporated herein and form part of the specification, illustrate the embodiments of present invention and, together with the description, further serve to explain the principles of the invention and to enable a person skilled in the relevant art(s) to make and use the invention.

FIG. 1 depicts a flow cytometer according to an embodiment of the present invention.

FIG. 2 illustrates an excitation system with fixed mechanical alignment to the sample stream, according to an embodiment of the present invention.

FIG. 3 illustrates an excitation system and collection system with fixed mechanical alignment to the sample stream, according to an embodiment of the present invention.

FIGS. 4A, 4B, and 4C illustrate an array of optical fibers providing fixed alignment of multiple radiation sources to a sample stream.

FIG. 5 illustrates a direct attachment and incorporation of optical components to modify the fixed alignment excitation and collection systems, according to an embodiment of the present invention.

FIG. 6 illustrates the use of fiber optical connectors to allow disconnection and connection of optical fibers, according to an embodiment of the present invention.

FIGS. 7A, 7B, and 7C illustrate an excitation system including that of an improved tolerance to sample stream movement, according to an embodiment of the present invention.

FIG. 8 illustrates an exemplary example of a refractive optical beam shaper system to create a flat-top spatial intensity beam profile, according to an embodiment of the present invention.

FIG. 9 illustrates an array of multiple light sources through a common beam shaping optic for stream sampling at a plurality of optical excitation locations, according to an embodiment of the present invention.

FIG. 10 illustrates the use of a plurality of fiber optic excitation sources in an array that conditions all of the light sources with a common beam shaping optic for stream sampling at a plurality of optical excitation interrogation points, according to an embodiment of the present invention.

FIGS. 11, 12A, 12B, 13, and 14 illustrate various particle analyzers, according to various embodiments of the present invention.

FIG. 15 illustrates a particle analyzer system, according to an embodiment of the present invention.

FIG. 16A illustrates a core stream with an elliptical beam, according to an embodiment of the present invention.

FIG. 16B illustrates a core stream with a flat-top beam, according to an embodiment of the present invention.

FIG. 17 illustrates two, two-dimensional graphs of radiation beams, according to an embodiment of the present invention.

FIG. 18 illustrates a focused radiation beam, according to an embodiment of the present invention.

The features of various embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

Although embodiments are applicable to any system or process for analyzing particles, for brevity and clarity a flow cytometry environment is used as an example to illustrate various features of the present invention.

Before describing such embodiments in more detail, however, it is instructive to present an example environment in which embodiments of the present invention can be implemented.

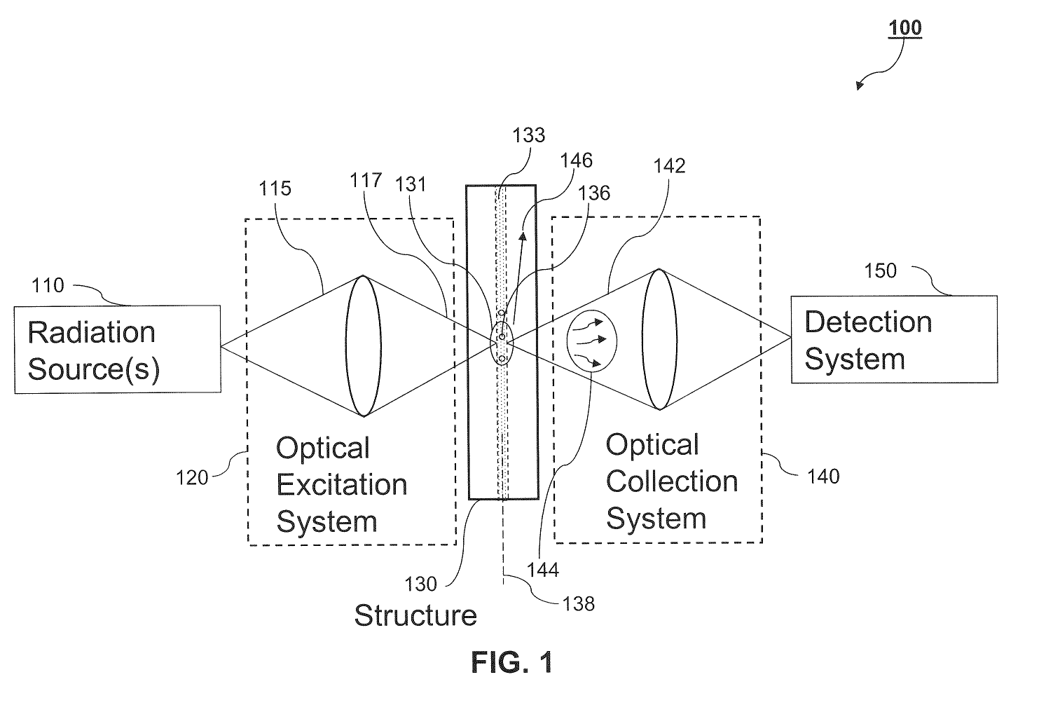

FIG. 1 depicts a flow cytometer system 100, according to an embodiment of the present invention. In one example flow cytometer system 100 includes one or more radiation sources 110, an optical excitation system 120, a structure or air space 130, (hereinafter referred to as structure), a sample stream 133 including particles 136, an optical collection system 140, and a detection system 150.

In one example, light from one or more optical radiation sources 110 is guided by excitation optical system 120 toward structure 130 guiding sample stream 133. In one example, structure 130 consists of an air space that surrounds sample stream 133. Light interacts with particles 136 flowing in sample stream 133. The light resulting from that interaction, such as scattered or excited fluorescent light, is directed by collection optical system 140 onto detection system 150. In one example, the detected information is analyzed by electronics and software, which are not shown.

In one embodiment, scattered light is meant to include any type of forward, side, or backward scattered light, reflected light, and absorbed light.

In one example, radiation sources within element 110 can be lasers, although arc lamps, light emitting diodes, or other optical radiation sources can also be used. More than one laser can be used, where each laser can emit optical radiation of a unique optical characteristic, for example, but not limited to, optical wavelength, wavelength band, polarization, pulse width, or other optical characteristics in order to measure a response of the sample particle to different optical excitation stimuli.

In one example, optical system 120 or 140 can comprise mirrors, lenses, prisms, optical fibers, diffractive elements, optical waveguides, or other optical components. It is to be appreciated that one of ordinary skill in the art will understand that in one example the optical components can be positioned by discrete mounts, e.g., metal mounts, that are attached to a plate or other mechanical base or linkage in the flow cytometer, which are not specifically shown.

In one example, beam 115 can be focused using optical system 120 so that a focal region 131 is created within sample stream 133 where the light energy is condensed into a small volume. The focal region 131 can be located where the light that intercepts the sample particle is most concentrated to maximize the response of particle 136 to the interrogation from radiation source 110.

In one example, multiple light sources are used in radiation source(s) 110. When multiple light sources are utilized, multiple focal regions can be formed. The focal regions can be separated by a finite spacing along the sample stream axis (not shown), in order to facilitate the collection of scattered and fluorescent light for detection, as is described below.

In one example, sample particles 136 can flow in a single file order. For example, although not shown, the (core) stream of particles 136 can pass through a nozzle and be hydrodynamically guided by a surrounding (sheath) fluid stream prior to passing by the optical radiation interrogation region 136. The core and sheath stream 133 can be contained within structure 130, e.g., an optically transparent fluid duct, possibly a cuvette, or the stream can be discharged from a fluid guiding system (not shown) into the air. In various examples, the sample particles 136 can be discarded after measurement or the particles 136 can be selected, based upon their measured properties from the optical interrogation, and made to collect in different groups for further analysis, as in a sorting flow cytometer.

In one example, the sample particles 136 e.g., can produce side scattered light 146, forward scattered light 142, fluorescent light 144, or back scattered light (not shown). Forward scattered light 142 can be based on interacting with beam 115/117. Fluorescence light 144 can be based on emitting light with photons of different energy than the source light, depending upon whether an appropriate fluorochrome or other light-emitting material has been added to particle 136, or, for example, by autofluorescence. In another example, non-linear effects, e.g., using a two photon emission process to create higher energy emitted photons, can also be used. Forward scattered light 142 and possibly fluorescently emitted light 144 can be captured by optical system 140, which guides light 142, 144, and 146 from sample interaction region 131 to detector system 150. Forward scattered light 142, side scattered light 146, and fluorescently emitted light 144 can be produced and captured at any angle relative to sample particles 136. Collection optical system 140 can also be made up of mirrors, lenses, prisms, optical fibers, or other optical components, which are e.g., positioned by discrete mounts attached to a plate or other mechanical base or linkage in the flow cytometer. Collection optical system 140 generally is not comprised of the same optical elements as system 120, although there can be some common optical element types shared by both the excitation and collection systems 120 and 140. Forward scattered light 142 can be collected in a direction generally opposite the direction from which beam 115 impinges upon sample stream 133. Other scattered light 146 can be collected in a direction that is generally orthogonal to the direction of beam 115, which is referred to as side scatter. In addition, any resulting fluorescent emission 144 from the sample particles 136 can be collected in a direction that is also orthogonal to beam 115 impingement upon the sample stream 133.

In one example, collection system 140 and/or detection system 150 can include filters or other elements that separate the collected light 142, 144, and 146 into discrete optical wavelength bands, and can include photo sensitive electro-optical detectors that convert the optical radiation in these wavelength bands into electrical signals. Analysis of the relative distribution of signals, corresponding to the various wavelength bands, provides information on the nature of the sample particles 136 that have been measured in the flow cytometer 100.

In one example, the forward scattered light 142 can be of relatively high intensity that can be filtered to reduce its intensity or to isolate the wavelength of detected light to a narrow wavelength band centered on the laser emission wavelength. Detection system 150 can have a relatively low sensitivity optical detector, such as a photodiode, which can be used to measure forward scattered light 142. In one example, directly transmitted, non-scattered laser source light can be physically blocked from collection by the forward scatter detector.

In one example, side scattered light 146 can be collected by either reflection from or transmission through an optical filter (not shown) in either the collection system 140 or the detection system 150. The filter can also prevent side scattered light 146 from reaching a fluorescence detector portion of detection system 150.

It is to be appreciated other parameters regarding light interacting with a sample can also be detected, such as polarization, angular distribution, etc. without departing from the scope of the present invention.

In one example, fluorescent light 144 can be of very low intensity compared to the scattered laser light. If this occurs, the laser light can be optically filtered within the collection system 140 or the detection system 150 and be blocked from the highly sensitive fluorescent detectors. The fluorescent light 144, which has been captured by the collection optical system 140, can be separated into different optical wavelength regions or bands, often by the use of dichroic optical filters. A single, very sensitive photo detector within detection system 150 can measure the fluorescent light 144 in each of the separate wavelength regions, so that the relative fluorescent emission of the sample 133 in each wavelength band can be analyzed. Due to the very small fluorescence signal intensities and the e.g., short amount of time the flowing sample particles 136 fluoresce during their transit through the source light interrogation region 131, the fluorescence detectors can be extremely sensitive and fast in their response to optical irradiation. For these reasons, the fluorescence detectors can be configured with photomultiplier tubes or other detector technologies.

When multiple source lasers of different excitation wavelengths are part of radiation source(s) 110, these lasers are can be focused at locations that are spatially separated along the sample stream flow axis 138. Scattered light 142 and 146 or fluorescently emitted light 144 from each interrogation location can be geometrically separated by the collection optics system 140 to guide the light to the appropriate optical filters and detectors, e.g., of detection system 150, which can correspond to the particular excitation wavelength.

In one example, any change of the alignment of lasers in radiation source(s) 110 or their focal position relative to sample stream 133 can alter the measurement results. In an extreme case, beam 117 can miss particle 136 as it flows through interrogation region 131, so that particle 136 is never irradiated by beam 115.

In one example, a spatial intensity profile can be a Gaussian distribution across the laser beam 115/117. In this case, at the point where the beam 117 interacts with sample particle 136 there can be very large differences in the probability of detection of particle 136 depending upon where particle 136 traverses through that Gaussian intensity distribution profile. For example, if particle 136 passes through the center of interrogating laser beam 117, particle 136 can experience the maximum possible irradiation by beam 117, which can create a relatively strong fluorescence or scatter signature. If the same particle 136 were to pass through the outer edge of the Gaussian intensity profiled laser beam 117, however, the irradiation can be drastically lower, so the resulting scatter or fluorescence signal can correspondingly be much smaller. Therefore, to maintain consistent and reliable measurement capability, the relative alignment and positioning of the optical excitation system 120 and the sample stream 133 should be held substantially constant over the time of many measurements.

In one example, optical collection system 140 and detection system 150 remain in constant alignment relative to sample stream 133, but the one or more source interrogation locations 131 may not stay in alignment with in the sample stream 133. For example, relative movement of the source excitation points 131 on the core stream 133 might be geometrically relayed by the collection optics 140, with the result that movement of the scattered and fluorescent light 142, 144, and 146 occurs in a three dimensional relationship to detection system 150, changing the apparent intensity of the collected light. Similarly, movement of the sample stream 133 relative to the position of the collection optics 140 can change the focus and size of the collected light spot on the detection system 150, possibly overfilling an aperture, which can again affect the apparent intensity of the collected light.

It can be appreciated that it is e.g., difficult to achieve and maintain the opto-mechanical alignment of the light sources 110, excitation optical system 120, sample stream 133, collection optical system 140, and detector system 150, due to the many interdependent variables. If the source laser experiences thermal instabilities, for example, the beam pointing can change, which can misalign beam 115 through excitation optics 120, and misplace beam 117 or its focal region 131 relative to the path of sample stream 133, changing the intensity of the interrogation of sample stream 133, or in some arrangements particle 136. This misalignment might also affect the collection and detection of any resulting scattered laser light 142, 146 or sample fluorescence 144 that occurs at the sample, further compromising the quality of the measurement. Other opto-mechanical positioning and alignment changes can occur between flow cytometer components and systems with changing environmental conditions, such as thermal variations or mechanical vibrations. This can necessitate frequent, time consuming adjustments of the various components and systems to maintain proper alignment and consistent performance characteristics in the flow cytometer 100. Any additions or changes to the optical components or systems can also require laborious procedures to achieve accurate alignment, although it can be very difficult to exactly replicate the performance of the system prior to the modification. These issues can be resolved through the embodiments discussed below.

In addition, the sample stream flow 133 can also be inherently unstable. Ideally, particles 136 will travel straight along a center axis 138 of sample flow 133. However, the paths of the particles 136 within the sample stream 133, and the shape of the overall sample stream 133, can vary due to changes in fluid dynamics. The fluid dynamics are e.g., affected by the environment, the fluidic control system, and the sample properties, etc., which can cause instabilities in the sample stream 133 over time. Even if the flow cytometer system 100 is otherwise optomechanically stable, the sample stream fluid dynamic changes can be a source of error or uncertainty in measurements. These issues can be resolved through the embodiments discussed below.

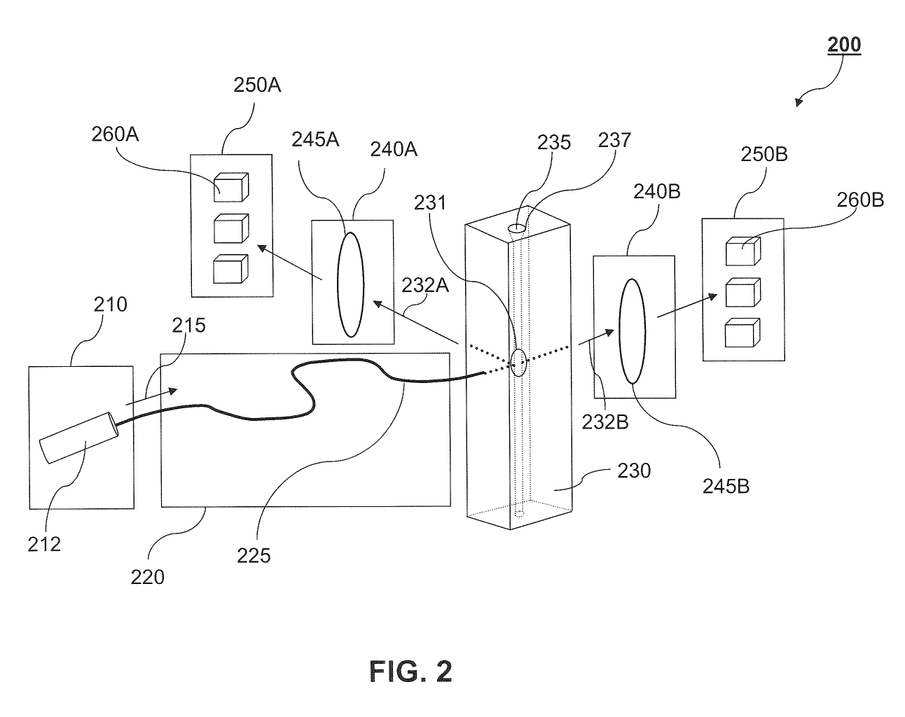

FIG. 2 illustrates an excitation system 200, according to an embodiment of the present invention. In the example shown, system 200 includes a source 210, an optical system 220 including a waveguide 225, a structure 230 that guides sample stream 235, an optical collector 240A with an objective lens 245A, an optical collector 240B with an objective lens 245B, and detection systems 250A and 250B with electro-optical detectors 260A and 260B. In one example, objective lens 245A can be replaced with a mirror, e.g., a parabolic mirror. In one example, system 200 has a fixed mechanical alignment with structure 230, which guides the sample stream 235.

In one example, beam 215 emitted from radiation source 210 is delivered to sample stream 235 via optical excitation system 220. In this example, system 220 is directly and permanently attached to structure 230 that guides sample stream 235. As an example, radiation source 210, which might e.g., be a laser 212, generates beam 215 that is directed and coupled into waveguide device 225, e.g. fiber optics. Beam 215 is then guided through waveguide device 225 toward structure 230. Structure 230 can be a flow cell, cuvette, or air, through which sample mixture fluid 235 flows along pathway 237 that is optically transparent at the light wavelengths of interest. For streams that are not contained by a cuvette, structure 230 can support and constrain sample mixture fluid 235 flowing freely in or through air. In this example, waveguide device 225 is permanently affixed to structure 230. The excitation light exits from the optical fiber 225 and is made to impinge upon the sample 235 in a measuring portion 231 in the flowing fluid pathway 237.

As discussed above, when beam 215 interacts with sample 235, sample 235 can fluoresce and/or scatter the light. The fluorescence and/or scattered light can be captured by optical collection system 240A, which can include an optical objective lens 245A to collect the light and a series of subsequent lenses or mirrors to guide the light to detection system 250A. In detection system 250A, the light can be optically or spectrally separated, e.g., by an optical interference filter, an absorbing filter, a prism, a grating, or other known refractive, dispersive, or diffractive technique, into constituent wavelength regions, or bands, each of which are then converted to electrical signals by electro-optical detectors 260A. In an example, one or more of the aforementioned devices or techniques, e.g., an optical interference filter, absorbing filter, diffractive technique, etc., can be used by itself or in various combinations within detection system 250A to achieve the desired optical wavelength signal separation. In an embodiment, although radiation source 210 is remotely located from structure 230 containing sample stream 235, it is optically and mechanically connected by a continuous guiding mechanism, such as optical fiber 225 in optical excitation system 220, directly to structure 230. Thus, an output end of fiber optic 225 is placed very close to, and in direct, rigid, fixed alignment with, structure 230, and thus to sample stream 235, thereby nearly eliminating misalignment between beam 215 and the sample stream 235.

In another embodiment, multiple optical collection systems, e.g., 240A and 240B, and multiple detection systems, e.g., 250A and 250B, can be utilized in conjunction with the fixed excitation optical system. In this case, the fluorescent or scattered light 232A and 232B resulting from the interrogation of the sample particle by the radiation source 210 through excitation optical system 220 attached to structure 230 is captured by more than one optical collection system 240B, each of which e.g., contains an optical objective lens 245B to collect the light, and series of subsequent lenses or mirrors to guide the light to a detection system 250B. In detection system 250B, the light can be optically separated into desired wavelength bands that can be converted to electrical signals by electro-optical detectors 260B. The use of multiple collection systems can increase fluorescent light collection efficiency or can allow for separation of the fluorescent and scattered laser light optical collection and detection systems.

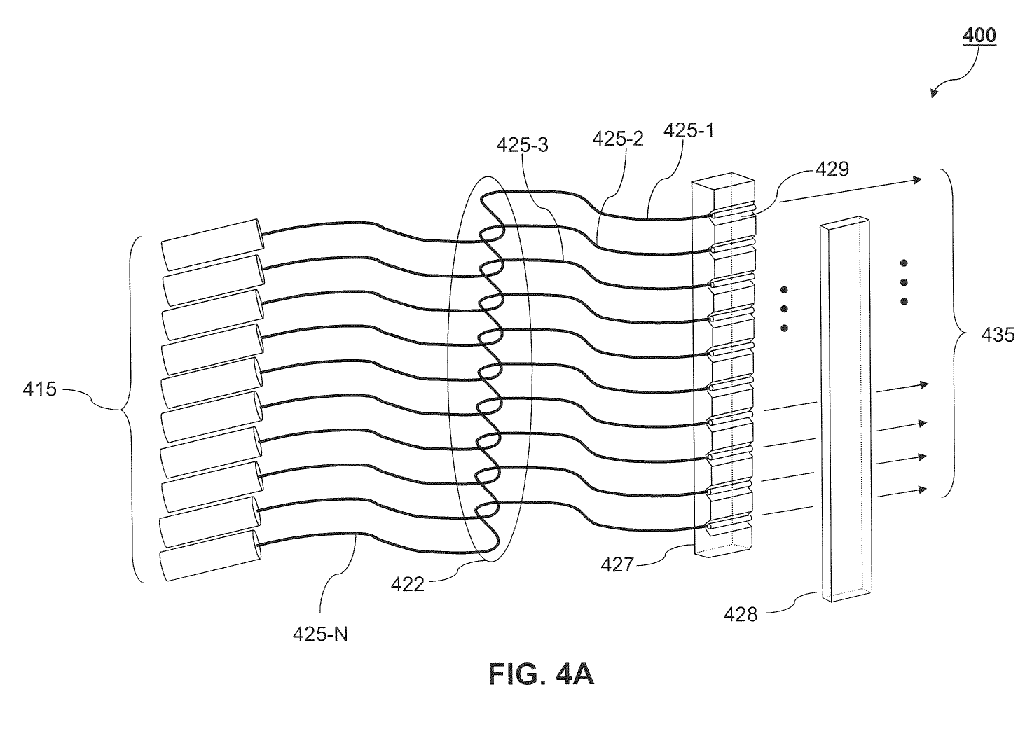

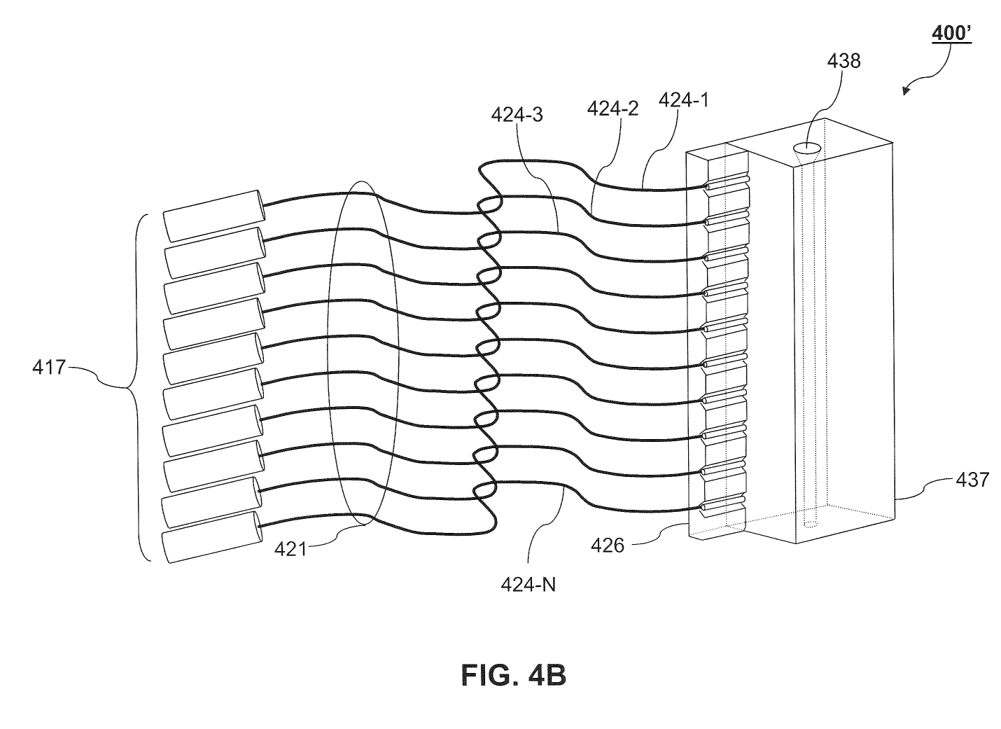

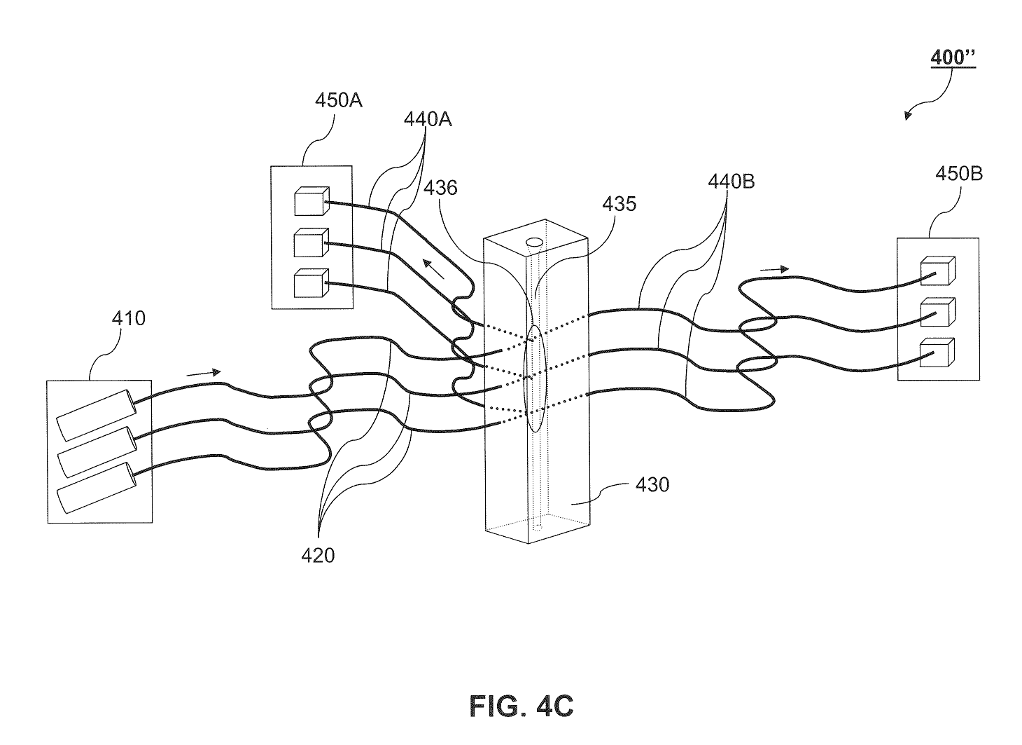

The fixed attachment of the fiber optic from the optical excitation system 220 to structure 230 containing the sample stream can be performed using different mechanisms. In one embodiment, structure 230, e.g., a flow cell or cuvette, can be modified to hold the optical fiber tip. For bare fiber, this can be done using e.g., a laser, water jet, ultrasonics, or a core drill, to bore a hole in the side of the cuvette, then using epoxy, such as optical index matching cement, to attach the fiber into the hole. Alternatively, a small “vee” block can be cut into a glass, ceramic, or other substrate, into which the fiber optic end can be laid with its cylindrical surfaces in tangential line contact with the two sides of the vee block. A second, flat, cover plate can be attached or bonded over the fiber laid into the vee groove to provide a third line contact on the fiber barrel surface (a plurality of fiber attachments by this mechanism is illustrated in FIG. 4A). This vee-block mounted fiber optic assembly can be bonded to structure 230, e.g., a cuvette, at a desired location, relative to the sample stream flow.

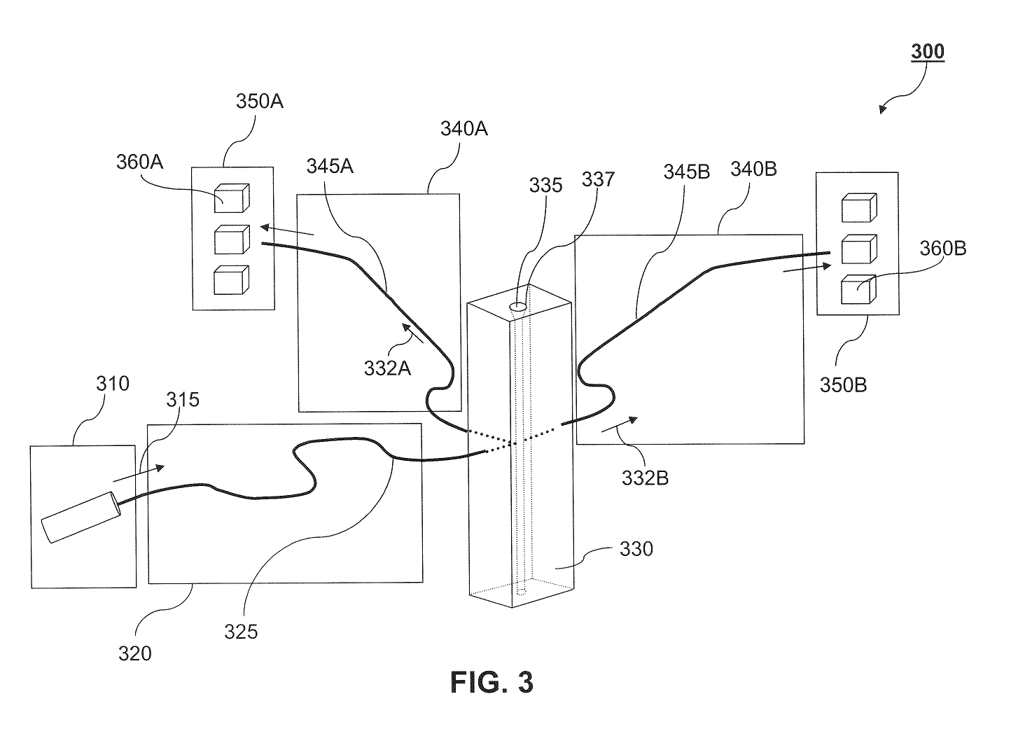

FIG. 3 illustrates an excitation and collection system 300 with fixed mechanical alignment to the sample stream, according to another embodiment of the present invention. In one example, excitation and collection system 300 includes a source 310, an optical system 320 including a waveguide 325, a structure 330 that guides sample stream 335 through a pathway 337, optical collection systems 340A and 340B with waveguides 345A and 345B (e.g., fiber optics, etc.), and detection systems 350A and 350B with electro-optical detectors 360A and 360B.

In one example, beam 315 emitted from radiation source 310 is delivered to sample stream 335 via optical excitation system 320 that can be directly and permanently attached to structure 330 that guides sample steam 335. The fluorescent or scattered light, e.g., 332A and 332B, resulting from the interrogation of the sample particle by radiation beam 315, can be captured by one or more optical waveguides 340A and 340B, e.g., optical fibers, which are also directly affixed to structure 330 containing sample stream 335. The captured light 332A and 332B is guided through waveguide 345A towards detector system 350A. In detector system 350A, the fluorescent or scattered light 332A and 332B can be optically separated into constituent wavelength regions or bands that can be converted to electrical signals by electro-optical detectors 360A and 360B. For example, the separation of light into different wavelength bands can be performed by passing the light from collection waveguide 345A through a system of optical filters (not shown) and components that spectrally filter and guide the light to individual electro-optical detectors 360A. Spectral filtering can be performed in several ways, including the extraction of light from the fiber into free-space optical components, or through the use of specialty fiber optic components such as those used in optical fiber telecommunications applications. In an alternative example, a plurality of optical collection systems 340A, 340B, and waveguide 345A, 345B can guide collected fluorescent and scattered laser light to detector systems 350A and 350B.

In one example, as shown in FIG. 3, both input (excitation optical system 320) and output (collection optical waveguides 340A or 340B) fiber optic systems are directly, physically connected, and their relative positions held constant to structure 330 and to each other. There are no independently mounted, discrete optical elements between the light source and the cuvette, or between the cuvette and the detection fiber. It can be appreciated that this arrangement can present the least opportunity for physical misalignment between the various systems and the sample stream over time, although the optical interrogation of sample particles by the excitation beam, and the subsequent collection of any fluorescent or scattered laser light may not be optically efficient without the addition of beam modification optics or specialty optical fibers, for example, which can perform internal beamshaping prior to exciting the sample.

In one example, fixedly mounting alignment optical excitation and collection systems can prevent performance changes in the flow cytometer measurements, which can otherwise be due to the relative movement between discretely mounted optical and mechanical components over time. Even if positional changes are not entirely eliminated, the embodiments of the present invention can greatly reduce their magnitude and effect. For example, if mechanical or thermal changes or stresses were to occur to the assembly of the structure containing the sample stream, and its attached optical fibers, the very close proximity of the excitation light launching from the fibers onto the sample stream, and the resulting collection of light arising from the fluorescing or scattering sample into the closely placed fibers, can minimize the effect of mechanical distortions in the structure or optical fiber mounts. A much larger angular movement between the directly mounted fiber tip and the structure, for instance, can be tolerated at a longitudinal distance, measured from the fiber tip to the sample stream, which is much smaller than that for a discretely mounted fiber optic tip that is located relatively far away from the sample stream. By directly mounting the fiber to the structure containing the sample stream, and by using similar types and sizes of materials to make up the sample stream structure itself, the effect of using external mountings with dissimilar sizes and dissimilar thermal expansion coefficients, for example, can be greatly reduced.

FIGS. 4A, 4B, and 4C illustrate the use of an array of optical waveguides in systems 400, 400′, and 400″ to provide fixed alignment of multiple radiation sources to the sample stream according to multiple embodiments of the present invention. In the example shown, system 400 includes one or more radiation sources 415, an excitation waveguide 422 consisting of individual optical fibers 425-1 through 425-N whose distal ends are affixed to a fixture 427 and covered by a cover plate 428.

As shown in FIG. 4A, radiation sources 415 can be guided by optical excitation systems 422 to a fixture 427, which locates and fixes the alignment of the source excitation outputs relative to each other. For example, as shown in FIG. 4A, several (N) optical radiation sources, which can be lasers, are each coupled to waveguide 422, generally optical fiber 425-1 through 425-N, and the excitation light guided to fixture 427, to which the fibers are rigidly affixed. Fixture 427 positions each of the optical excitation fiber ends in a known and constrained position, prior to the rigid attachment of fixture 427 to a structure (not shown) surrounding the sample stream. In one example, fibers can be spaced apart some nominal distance along an axis that is generally along the direction of the sample stream flow. This can provide sequential excitation of the particles from radiation 435 as the particles flow in the sample stream past the plurality of optical interrogation points, and can accommodate spatial separation and collection of any resulting fluorescence and scattered laser light for the detection system. Similar to as described earlier in the single fiber case, the plurality of fibers 422 can be affixed to fixture 427 by fabricating an array of small “vee” grooves 429 in a glass, ceramic, or other substrate, into which the fiber optic ends can be laid, with their cylindrical surfaces in tangential line contact with the two sides of the vee groove. The fiber ends can then be glued into the vee grooves directly, or a second, flat, cover plate 428 can be attached or bonded over the fibers laid into the vee grooves to provide a third line contact on the fiber barrel surface.

As shown in FIG. 4B, system 400′ includes multiple radiation sources 417. In system 400′, radiation is guided by optical excitation waveguides 421, consisting of multiple optical fibers 424-1 through 424-N, to a fixture 426 that is affixed to a structure 437 through which there exists a sample stream flow path 438. In an embodiment, this type of vee-groove mounted fiber optic assembly can be bonded to structure 437, generally a cuvette, at the appropriate location, relative to sample stream flow path 438, to provide optical irradiation of the flowing samples. In another example, fixture 426 or structure 437 containing the sample stream can be modified to accept and hold the optical fiber tips, such as by boring an array of holes in the side of the fixture or structure, then using epoxy, such as optical index matching cement, or a glass frit bond, or fusion weld, etc., to attach the fibers into the array of holes.

FIG. 4C illustrates system 400″ where a plurality of fibers is attached on both the optical excitation side of a structure that contains a sample stream, as well as on the fluorescence and laser scattered light collection sides of the structure, according to an embodiment of the present invention. In the example shown, system 400″ includes one or more excitation radiation sources 410, one or more waveguides 420, a structure 430 through which there exists a sample stream flow path 435, one or more collection waveguides 440A and 440B, and detectors 450A and 450B. The excitation radiation sources 410 can be guided by fiber optics 420 to the structure 430 containing the sample stream flow path 435, and the resulting fluorescent and scattered laser light can be captured by one or more optical collection systems 440A, 440B, etc. to direct the light for further spectral processing and measurement in detection systems 450A and 450B.

In this example, the plurality of excitation radiation sources 410 can allow the use of several different lasers, each emitting light having different characteristics, e.g., in a different wavelength region and/or polarization state, so that a given sample particle can be irradiated by each of the different sources in succession in the irradiation area 436 as the sample flows past the array of fiber optic ends that are attached to structure 430. In another example, several different lasers emitting in the same wavelength region, but with different output powers or other properties can be used to interrogate the sample particle with light of different intensity or characteristics that can be useful in analysis of the particle.

In one example, a compact nature of the array of fiber tips attached to the input and output of the structure containing the sample stream can permit the use of many excitation sources or different collection systems without the need to fit a large number of discrete optical components into a small space around the sample interrogation region of the flow cytometer. In another example, this arrangement of optical fibers in the optical excitation system can allow the excitation sources to be located remotely from the sample measurement area, thus affording great flexibility in the mechanical mounting of, and system interface to, the excitation lasers.

In one example, using the excitation system and collection system with fixed mechanical alignment to the sample stream, and the use of an array of optical fibers to provide fixed alignment of multiple radiation sources to the sample stream, and fixed arrays of optical fibers to collect light from the sample interaction with the source light, as described in the embodiments illustrated in FIGS. 3 and 4A, 4B, and 4C, within the restrictions of optical fiber and flow cell connector tubing length and strength, it is possible for the flow cell to be moved independently of the remainder of the flow cytometer apparatus, without disturbing the fixed alignment of the excitation and collection systems, relative to the sample stream location.

With an independently locatable sample measurement assembly, made up of the structure containing the sample stream, and the excitation and collection waveguides or optical fibers that are rigidly mounted to the structure, this assembly can be isolated from thermal and vibrational changes that might affect sample flow characteristics. For example, the sample measurement assembly can be placed inside an insulated enclosure, to reduce the rate and amount of ambient or instrument generated thermal changes in the flow cytometer sample stream. In another example, the sample measurement assembly can be contained in an enclosure that can isolate or dampen the assembly from mechanical vibration and shock, which can affect the sample stream. In another example, the assembly of the sample stream structure and attached fiber optics can also be placed in an advantageous location, which can potentially be much smaller than, and separated from, the e.g., large and bulky remainder of the flow cytometer instrument, which might allow more efficient use of laboratory space.

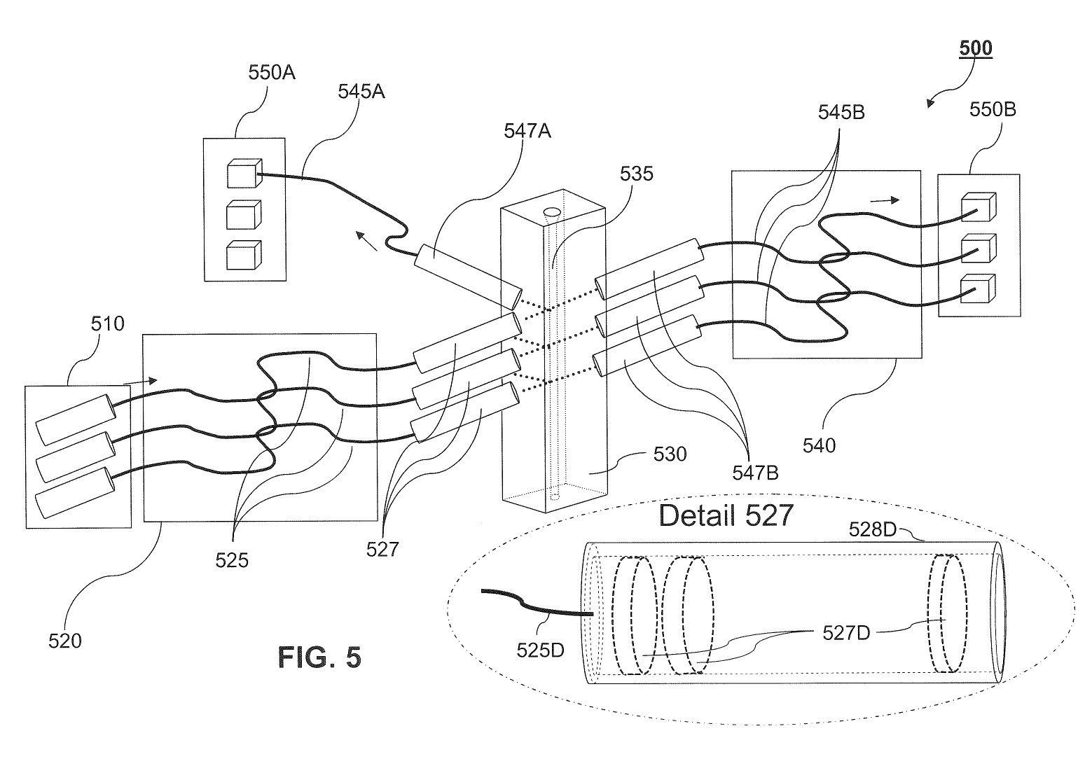

FIG. 5 illustrates system 500, according to another embodiment of the present invention. In one example, optics that modify the optical excitation system or the optical collection system can be directly attached and incorporated into the fixed optical alignment system. In the example shown, system 500 includes one or more excitation radiation sources 510, an excitation optical system 520 containing one or more waveguides 525, beam modification optics 527, 547A, and 547B, a sample stream structure 530 including a sample stream flow path 535, collection waveguides 545A and 545B, and detectors 550A and 550B.

In some cases, the optical interrogation of sample particles by waveguide 525, e.g., fiber optics, of excitation optical system 520 and excitation radiation sources 510, and the subsequent fiber optic collection system 540 of any fluorescent or scattered laser light may not be possible or optically efficient without the addition of beam modification optics 527, 547A, and 547B. If excitation source light from radiation sources 510 is not concentrated upon the sample particles in sample stream path 535, and the emitted fluorescent and scattered laser light is not focused into fiber optic collection system 540, much of the light involved in both processes can be lost as the light spills outside of the excitation optical system 520 and subsequent fiber optic collection system 540 and optical collection systems 545A and 545B to direct the light for further spectral processing and measurement in detection systems 550A and 550B. Therefore, as an example, a lens, lenses, or other focusing, optical beam shaping, polarizing, or other light conditioning elements 527D can be placed between the optical fibers 525D and the structure containing the sample stream in sample stream structure 530, if elements 527D are directly and rigidly attached to both fiber optic 525D and sample stream structure 530. In one example, elements 527D are small in form factor. In another example, optical controlling features are directly fabricated into or upon the fiber optic, so they can be mounted or bonded into a single, rigid unifying mount structure 528D, such as a ferrule or other housing that is preferably made of stable, low thermal expansion material, which is preferably compatible with, or even the same material as sample stream structure 530 containing the sample stream.

In one example, bonding unifying mount structure 528D to sample stream structure 530, either on a face or in a bored hole or as a clamp, such as a vee-block arrangement, can make a very mechanically and thermally stable connection. The bonding can be done by e.g., optical or other cement, by optical contacting, fit bonding, pressing, or other techniques that result in a good, strong connection. Unifying mount structure 528D, or housing, can be directly affixed to both fiber optic 525 and sample stream structure 530 containing sample stream 535.

Other embodiments include arrangements for attaching the fibers to the sample stream structure 530 includes using a piece of optical fiber that is mounted perpendicular to the output face of the fiber optic that emits excitation light onto the sample. This fiber can act as a cylindrical lens, and it can produce a line focus that can provide a flat intensity profile over the width of the sample flow column. One or more fiber optics can be combined with a lens, on either the input or output of the structure containing the sample stream, to allow the focusing or collection from spatially separated locations along the sample stream, based upon the relative separation of the fiber ends prior to the larger diameter lens. In addition, a bundle of fiber optics, which has the individual fibers laid out as a linear array at the distal end, and a circular bundle at the input end, can be used to provide an elliptical or linear-biased excitation beam intensity cross-section at the sample, even with a circular Gaussian beam intensity profile from the laser coupled into the input end of the fiber bundle.

One or more of the above embodiments or examples can be an improvement over beam modification optics that are mounted on a common base plate, but in discrete, independently attached fixtures, which are not directly attached to either the fiber optic or the structure containing the sample stream, since all of these independently referenced components can move and drift in position relative to each other over time. Rigid in-line mounting of any needed optical beam conditioning components, along with the fiber optic, to the structure containing the sample stream can preserve the advantages of fixed alignment relative to the cytometer sample stream.

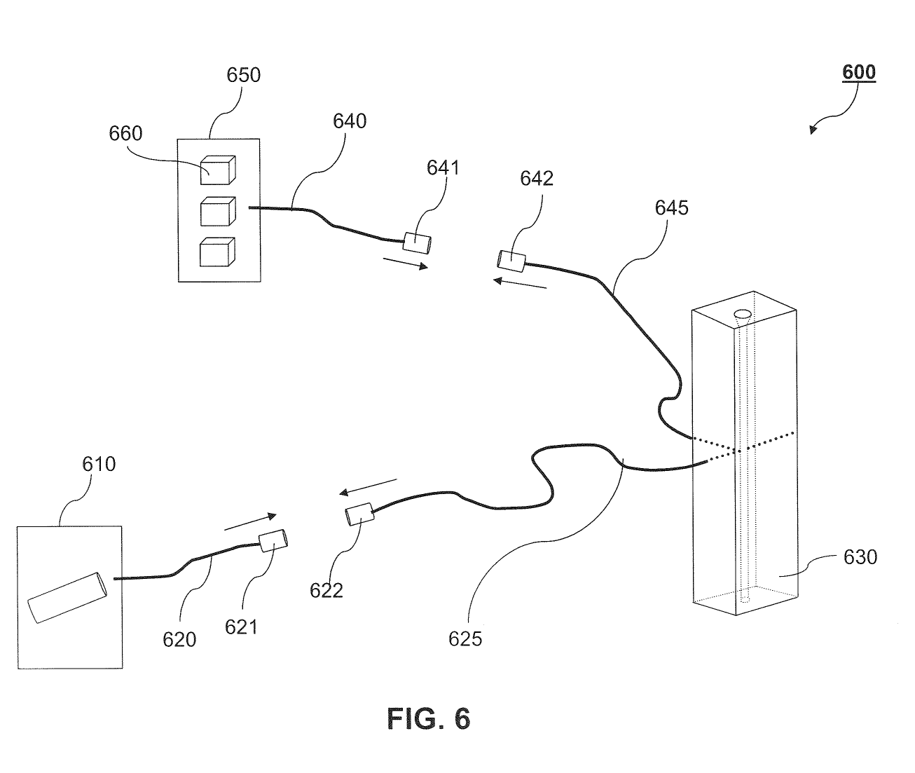

FIG. 6 illustrates system 600 with the use of fiber optical connectors to allow disconnection and connection of assembly that contains the structure surrounding the sample stream and its permanently attached excitation and collection optics, according to an embodiment of the present invention. In the example shown, system 600 includes one or more excitation radiation sources 610, an excitation waveguide 620 with an optical connector 621, a mating optical connector 622 and waveguide 625, a sample stream structure 630, collection waveguide 645 with an optical connector 642, a mating optical connector 641 with waveguide 640, and a detection system 650 with detectors 660. This system can provide quick and easy exchange of sample stream structure 630 and waveguides 625 and 645 by the use of connectorized optical fibers. In this example, optical fibers 625 and 645 can extend from their fixed, aligned mounting on sample stream structure 630, e.g., a flow cell, and they can terminate at some point in standardized optical fiber connectors 622 and 642, such as those used in the telecommunication industry. With the proper choice of mechanism, these fiber optic connectors generally have very tight mating tolerances and high mechanical location repeatability. On the flow cytometer, the excitation radiation source 610 and detection system 650, including detectors 660, can be coupled to optical fibers 620 and 640, respectively, which terminate in fiber optic connectors 621 and 641. These fiber optic connectors 621 and 641 can mate to or separate from the appropriate connectors 622 and 642 coming from the sample stream structure 630 and fiber 625 and 645 combination. This ability to connect or disconnect the sample stream measurement assembly can greatly simplify the installation and replacement of the structure that contains the sample stream, particularly in the field, since no alignment can be necessary after connecting the manufacturer's pre-aligned combination assembly of sample stream structure 630 and fibers 625 and 645 to the light source and detectors.

In another example, fibers 625 and 645, which are attached to sample stream structure 630, are connected to coupling optics to transfer the waveguided light to free-space optics at distal end termination 622 and 642, away from structure 630. Beyond the termination of the fiber, ancillary optics can guide the appropriate light from the source, similar to radiation source 610, into excitation optical fiber 625, or from collection optical fiber 645, out to detection system 650. This can still allow a great degree of freedom in movement of the sample measurement assembly 630, 625, and 645 without affecting the free-space, discrete optics portion of the system, since this portion can be mounted remotely from the sample measurement region. In addition, this can allow for interchangeability of different plug-in modules to perform various excitation beam conditioning or detection and analysis of sample-modified light in the system.

In one example, a module can be a cuvette coupled to optical fibers, where the optical fibers have integrated beam shaping elements. A first end of the optical fibers can be attached to the cuvette and a second end of the optical fibers can be configured with detachable connectors to connect to, for example, an illumination system, an optical system of an illumination system, a detection system, an optical system of a detection system, or the like. Many other modules are contemplated within embodiments of the present invention.

In one example, modules providing various optical properties can easily be interchanged by simply disconnecting a first module and connecting a second module. With this type of approach, various modules can be inserted in the system to accomplish a wide range of various desired optical functions without the need to redesign the entire system. This type of modularity offers increased flexibility, higher efficiency, and reduced cost when conducting a varied set of tasks requiring multiple functions.

After removing and replacing the sample measurement unit, the injection of light to, or launch of light from, the free space system can be aligned easily and in a controlled fashion since only one of the fibers 625 or 645, in this example, connect to sample stream structure 630, can be optimized at any given time. This can be an improvement over the replacement of the independent structure containing the sample stream, e.g., a flow cell, in a general analytical flow cytometer, because doing so requires moving the source excitation optics, the flow cell, and possibly the optical collection and detection systems, all relative to each other, in the case where these optics are discretely mounted in a free space optical system.

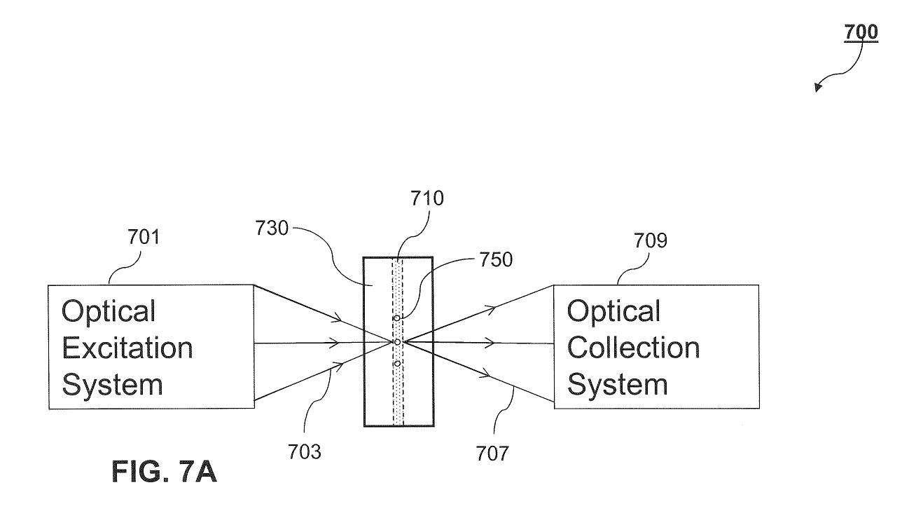

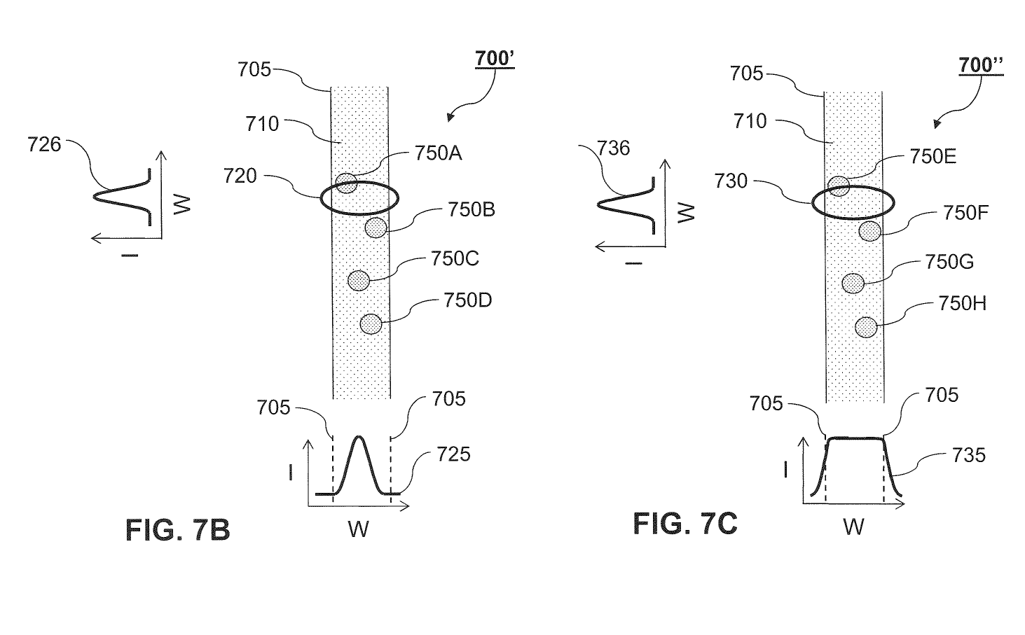

FIGS. 7A, 7B, and 7C illustrate excitation systems 700, 700′, and 700″ with an improved tolerance to sample stream movement, according to embodiments of the present invention. In these examples, a related approach to stabilizing a flow cytometer measurement by anchoring the optical excitation to the structure containing the sample stream, and subsequently to the optical collection system, is to modify the excitation optical system to be tolerant to changes in the behavior of the flowing particles in the sample stream. The particles within the sample stream may not always flow in a linear, well controlled path, and the sample stream shape and position can also change over time, due to environmental and other factors influencing the fluidic properties. Therefore, even flow cytometer systems with fixed optical alignment can experience instabilities in measurement performance. To improve this stability, the interrogating light beam of the optical excitation system includes a predetermined shape, e.g., a flat-top beam shaping optic, which can create a spatial light intensity profile that is significantly more uniform, over a greater distance across the width of the sample stream, and more concentrated into a narrower height along the core axis of the sample stream, than the e.g., Gaussian spatial intensity profile for a non flat-top laser beam.

In the example shown in FIG. 7A, system 700 includes an optical excitation system 701 that generates source radiation 703, a sample stream 730 that guides the sample stream 710 that contains particles 750, scattered and fluorescing beams 707, and an optical collection system 709. A beam 703 is modified by optics in the optical excitation system 701 to generate an anamorphic focused shape, which can be elliptical in cross section, rather than round, prior to interception of sample stream 710 and particles 750 contained within sample stream structure 730. Optical collection system 709 detects beams 707.

In the example shown in FIG. 7B, system 700′ includes a sample stream 705, a fluid 710 containing particles 750A, 750B, 750C, and 750D, that are exposed to radiation beam 720 with a cross-stream section 725 and a parallel-stream section 726. The size of the major and minor axes in the elliptical cross section of beam 720, as shown in FIG. 7B, can vary, and generally are chosen so that the wider axis of the ellipse is arranged perpendicular to the axis of the sample stream flow direction. In another embodiment, FIG. 7B illustrates sample stream 705, containing fluid 710, within which sample particles 750A, 750B, 750C, 705D, etc. are interrogated as they flow past source radiation beam 720, e.g., from a laser. The Gaussian spatial intensity profile of the beam cross section is illustrated in FIG. 7B for the cross-stream section 725 and the parallel-stream section 726. Note that both cross sections indicate a Gaussian intensity distribution across the width or height of the beam. It can be understood that a sample particle similar to 750C, located in the center of sample stream 705, as it passes source radiation beam 720, can be irradiated by significantly more source light than a sample particle similar to 750B, which is located at the periphery of sample stream 705, according to intensity profile 725. As any sample particle 750A, 750B, etc. traverses source radiation beam 720, it experiences a time-varying intensity according to the flow rate and intensity profile 726.

In the example shown in FIG. 7C, system 700″ includes a sample stream 705, a fluid 710 containing particles 750E, 750F, 750G, and 750H, that are exposed to radiation beam 730 with a cross-stream section 735, and a parallel-stream section 736. FIG. 7C, in another embodiment, illustrates the stability improvement benefit of the flat-top spatial intensity profile beam in providing tolerance for movement of the sample particles in the sample stream, relative to the excitation light source location. Source radiation beam 730 is modified by a flat-top beam shaping optic to create a spatial intensity profile cross section 735 that is uniformly and maximally intense over a wide distance across the sample stream flow axis. Cross section spatial beam intensity profile 736 is generally Gaussian in distribution along the sample flow stream axis direction, which can be desirable in some cases, according to the electronic and software response to the interrogation intensity profile with time, or this axis of the beam can also be made flat-topped in cross sectional profile, in another example. A sample particle similar to 750F, located away from the center of the sample stream 705, as it passes radiation beam 730, can be irradiated by nearly the same source light intensity as can be experienced by a sample particle similar to 750G, which is located at the center of the sample stream 705, according to intensity profile cross-stream section 735. As any sample particle 750E, 750F, 750G, 705H etc. traverses source radiation beam 730, it also experiences a time-varying intensity according to the flow rate and intensity profile 736. If the flat-top intensity profile radiation beam 730 is made to focus in a cross sectional shape that is more similar to a line or a rectangle than an ellipse, it can be appreciated that the time dependent response of a particle flowing through radiation beam 730 can be made more uniform regardless of the lateral position of the sample particle across the width of sample stream 705. A similar effect upon the time dependent response versus lateral position can occur in the arrangement as shown in FIG. 7B, if source radiation beam 720 were made to be more similar to a line or rectangle in cross sectional shape, rather than an elliptical shape.

The intolerance or tolerance of the sample irradiation to sample particle movement illustrated in FIGS. 7B and 7C can be extended in a similar fashion to the movement of the sample stream relative to the excitation light source position. This can occur by the lateral movement of sample stream 705 boundaries relative to the intensity profile of the Gaussian and flat-top beams 725 and 735. Any change in the shape or width of sample stream 705 can occur as the contraction or expansion, and possibly the lateral translation of sample stream boundaries 705 relative to intensity profiles 725 and 735. Thus, the measurement stability and tolerance of the flat-top beam to sample stream location and shape excursions is enhanced due to the wider, maximally flat cross sectional intensity profile of the beam.

In one example, a beam with a substantially uniform cross sectional intensity profile across a measurement or interrogation area, which can also be referred to as a significantly uniform spatial intensity profile beam, can be used. A beam having this profile can allow for more flexibility and tolerance in parameters of the system compared to a Gaussian profile beam. A uniform spatial intensity profile beam can be, but is not limited to, flat-top beam, a super Gaussian beam, or other similar beam shapes. Such beam shapes can provide a uniform intensity across the sample stream flow axis, which can allow for a maximum amount of uniform light intensity being delivered across the interrogation area, e.g., interrogated particles. The beam shape can also result in insensitivity of the detected information with respect to any undesired movement of a particle within the stream flow. In this example, measured information from the interrogation of the particle by the beam is substantially only based on the particle, and not on any non-uniformity of the beam at the area of interrogation.

In one example, an amount of a portion of a beam having the uniform in spatial intensity profile can be varied, e.g., application specific. In one example, an increase in the portion of the beam that exhibits uniform intensity proportionally increases an amount of compensation for relative movement of the stream with respect to the beam. By making the size of the portion of the beam having the uniform spatial intensity profile beam wider, more variation in relative movement between the stream and the beam can occur, while still allowing for desired measurements. Such movement of the stream with respect to the beam can be caused, for example, by the stream itself, or as a result of any component of the system moving due to, e.g., vibration, temperature change, etc. In one example, having this beam shape can also reduce a required power of a light source producing the beam since more of the beam in the interrogation area has a desired intensity profile.

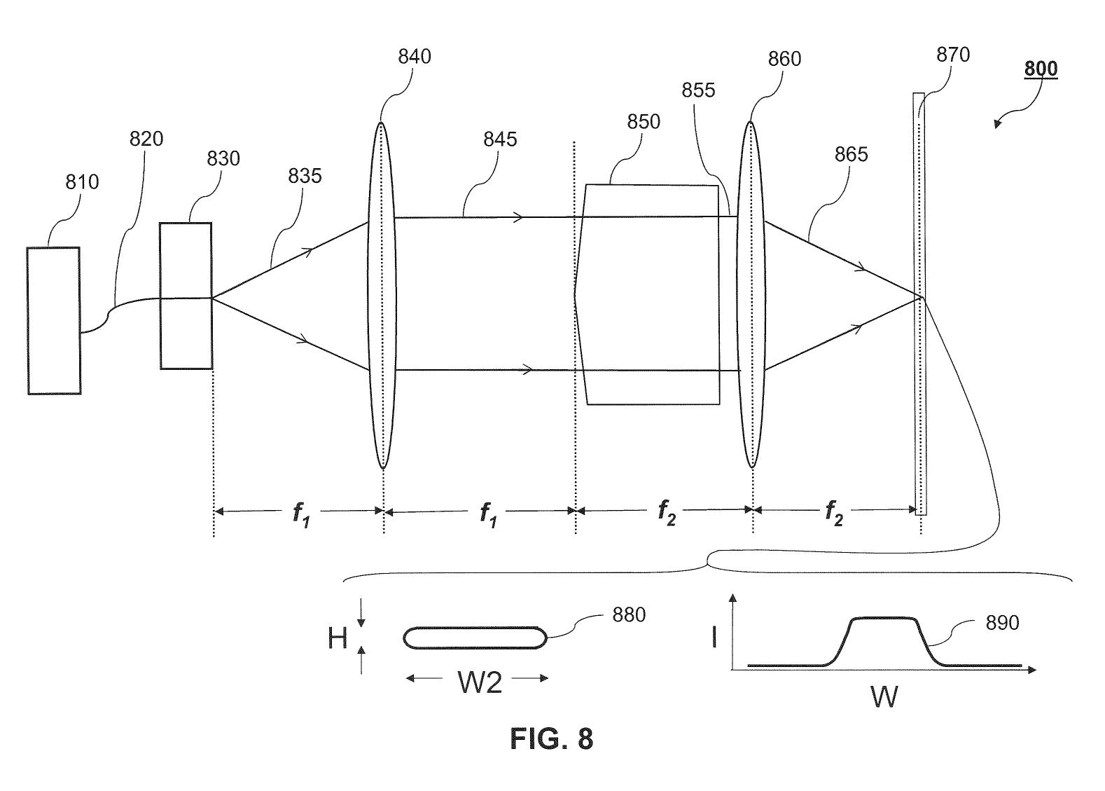

In an embodiment of the present invention, the uniform, e.g., flat-top, spatial intensity profile light beam can be generated in the optical excitation system by a refractive beam shaping optic, or BSO, as shown in FIG. 8. In the example shown in FIG. 8, system 800 includes an excitation radiation source 810, a waveguide 820, a waveguide termination block 830, beams 835, 845, 855, and 865, a collimating lens 840, a beam shaping optical element 850, a tertiary lens 860, a sample stream 870, and a beam cross section 880 with an intensity profile 890.

Excitation radiation source 810, which might e.g., be a laser, generates light that is directed and coupled into a fiber optic device. The light is then guided through waveguide 820, which can have a very small fiber “core,” that supports the propagation of only a single spatial mode of the laser light, to a location where the fiber optic terminates in waveguide termination block 830, and the light is launched back out of the fiber. Naturally diverging light 835 can be captured by a lens, reflector, or collimating lens 840 that concentrates and directs the light that is emitted from the fiber where beam 845 is directed to impinge upon beam shaping optical element 850. Collimating lens 840 is positioned such that the rays of the beam 845 are made nearly parallel and neither diverging nor converging after passing through collimating lens 840 of the appropriate numerical aperture for the given light wavelength. Beam shaping optic 850 is generally known as a Powell lens, which causes the light passing through it to form into a high aspect ratio linear or rectangular-like spatial intensity profile, which can be referred to as a line focus. A Powell lens provides unusually uniform irradiance along the long axis of the line-focused light pattern. This spatially dependent intensity profile can be referred to as a flat-top profile, for the uniform, maximal intensity of light along the length of the center of the irradiance pattern. Tertiary lens 860, inserted after collimating lens 840 and beam-shaping optic 850, can be used to focus the flat-top profiled light beam 855 down 865 to a size where the vertical height of beam cross section 880 of the light beam at sample stream 870 is very small, and the horizontal length of the cross section of the beam 880 is sufficiently wide enough to provide uniform illumination to the sample stream in the general flow cell, or stream in air, even if some variation occurs between the relative position of the interrogating light beam and the sample stream under measurement. High aspect ratio beam cross section 880, with flat-top cross section intensity profile 890, provides good temporal resolution to the measurement of a sample traveling across the narrow axis, and low sensitivity of the flow cytometer fluorescence signal to optical, mechanical, and fluidic positional variations of sample stream 870. The high aspect ratio shaped, flat-top intensity profile 890 is designed to concentrate a high interrogation light intensity into the sample with a uniform spatial distribution over a small area, which is an improvement over the deleterious effects of creating a e.g., very wide, low irradiance value Gaussian profiled beam in an attempt to create tolerance for sample movement.

In other examples of beam shaping devices, anamorphic telescopes, astigmatic focusing systems, prism-based systems, or other techniques, can be used to generate a high aspect ratio beam cross section shape and flat-top cross section spatial intensity profile.

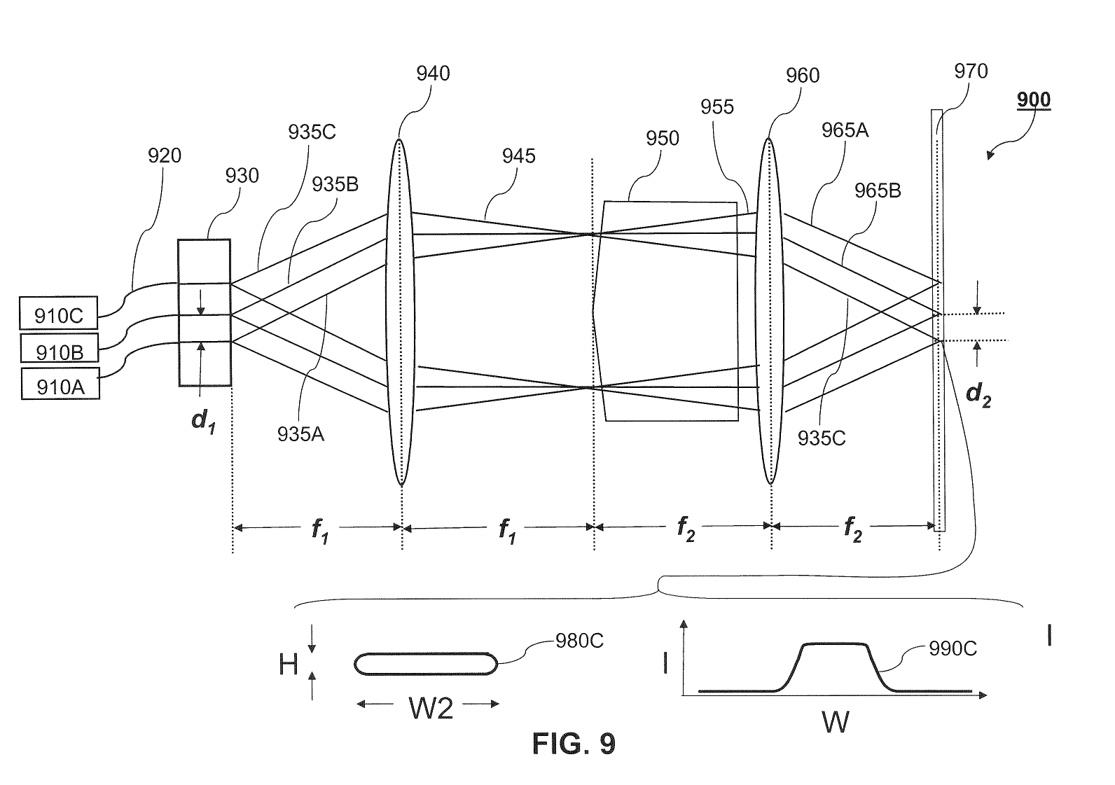

FIG. 9 illustrates system 900 with an arraying of more than one light source through a common beam shaping optic to provide tolerance to sample stream position changes to a plurality of optical excitation interrogation points, according to an embodiment of the present invention. In the example shown in FIG. 9, system 900 includes excitation radiation sources 910A, 910B, and 910C, a set of waveguides 920, an array structure 930, beams 935 (A, B, and C), 945 (A, B, and C), 955 (A, B, and C), and 965 (A, B, and C), a collimating lens 940, a beam shaping optical element 950, a focusing lens 960, a sample stream 970, and a beam cross section 980C with an intensity profile 990C. More than one laser or radiation source 910A, 910B, 910C, etc. can each be coupled to and guided by a waveguides 920, e.g., an optical fiber. The distal end of the optical fibers 920 can be arrayed in an array structure 930 at the input of the beam shaping optic assembly, such that each light source follows a unique path 935A, 935B, 935C through the beam shaping optic assembly that includes collimating lens 940, beam shaping optic 950, and focusing lens 960, which is common to all of the arrayed fiber optic light sources. For example, the spatial offset between fiber optic end centers 930, labeled d1, causes a deviation of the beam paths through collimating lens 940 and successive beam shaping optic 850 and focusing lens 960, which results in a spatial offset between the focused spots from each source 965C, 965B, 965A, which is labeled d2. The spatial separation of d2 can be determined by common relationships in geometrical optics, having to do with magnification through the beam shaping optic assembly, and is directly related to distance d1. In system 900, the array of fiber optics is contained in one plane, parallel to the paper in FIG. 9, with separation in one axis, so that the focused typical flat-top cross section intensity profile 990C linear beams, with cross section shapes (980C shown) are arrayed in the same plane, with spatial separation only in the same one axis.

In one example of creating an array mounting device, a succession of vee-grooves can be cut into a mounting block structure of suitable material, and the fiber optic buffer or ferrule at the terminated end can be bonded or otherwise mechanically constrained in the vee-grooves to produce a linear fiber array. In another example, the array can be formed by drilling an array of holes through a solid block or plate structure, then inserting the fiber termination ends into the holes and securing them in place, perhaps with adhesive or other mechanical constraints. The distal ends of the fibers can also be placed into grooves with rounded bottom rectangular “U-” forms, rather than triangular aspect “V-” forms, in another example. The cover plate for either the vee-groove or other linear fiber array mounting schemes can also have vee-groove, ridged, convex or concave cylindrical curved, spherical bumped, or other topographical or structural features to enhance or provide constraint and positioning of the fiber optics in the array.

In an example of the implementation of the multiple fiber array coupled BSO, to insure maximum optomechanical position alignment stability of the excitation system, the entire assembly of the beam shaping optic system can be rigidly affixed to all of optical fibers 920 or array structure 930 and the structure containing the core stream (not shown), as described in other embodiments of the present invention. In another example, the entire assembly of the optical beam shaping system can be rigidly attached to all of the optical fibers 920 or array structure 930, but made to be adjustable in position relative to the structure containing the core stream. The combined fiber array and beam shaping optic system can facilitate alignment to the sample stream in the flow cytometer, since all of the interrogation spots, from multiple sources, move together as one group as the position of the combined element is adjusted relative to the sample stream. The entire combined unit of the fiber array mount and the beam shaping optics can be moved in any number of axes or motions to allow alignment of the unit relative to the cytometer sample stream, in order to optimize focusing, minimize lateral core stream position sensitivity, and to align the excitation point in the core stream to match with the available fluorescence collection optics to capture the maximum signal from the sample, for several examples.

Array structure 930 can be permanently attached in a rigid manner to the beam shaping optic assembly (collimating lens 940, beam shaping optic 950, and focusing lens 960), which can immediately follow array structure 930, which can be configured with vee-groove array mounting.

In one example, array structure 930 with vee-groove mounting can be made removable from the remainder of the common beam shaper, for cleaning or replacement purposes. However, when attached to the beam shaper, the array can be rigidly attached in a fixed position relative to the beam shaper. In another embodiment, during initial fabrication of the fiber array and beam shaping device, the array can be made to move relative the remainder of the beam shaping optics, in order to facilitate optimization of positioning, optical throughput, and focusing of the various light sources in the array by the beam shaping optics.

If the array structure 930 is designed to be removable from the common beam shaping device, by using fiber optic connectors as described in another embodiment of the present invention, there is the potential for use of different arrays with different numbers of sources or different wavelengths of sources. These can be rapidly connected or disconnected from the flow cytometer sample interrogation system, without removing the beam shaping device, which can create a high degree of modularity in the assembly.

The ability to reduce the sensitivity of the flow cytometer excitation system to any fluctuations in the sample particle or sample stream location can be an improvement upon typical flow cytometer systems. Creating a potentially large number of optical excitation regions arrayed in a very small volume, compared to the equivalent space that can be needed for many large and discrete BSO devices on each source light beam path is also an improvement, in that more compact sample measurement systems can be realized.

Another improvement of at least some of the embodiments described is that all of radiation sources 910A, 910B, and 910C can interrogate sample stream 970 from a common angle, relative to the sample stream and the optical axis of the fluorescence and scattered light detection system. This can provide less ambiguity about the fluorescence or scattered light properties of the sample, since multiple sources will not be impinging on the sample from all different angles, and can lead to more uniform and repeatable measurements and interpretation of the resulting data.

In another embodiment, several fibers guiding optical source radiation of the same wavelength can be arrayed at the beam shaping optic input, and used to interrogate a sample with the same beam properties at different points in time. This can be used to provide time-resolved studies of sample changes in response to light exposure, or to allow exposure at multiple irradiation intensities but the same wavelength of light at different points in time, or to provide for interrogation of fluorescence by different polarization states of the same wavelength of excitation light at different points in time or spatial position, for example.

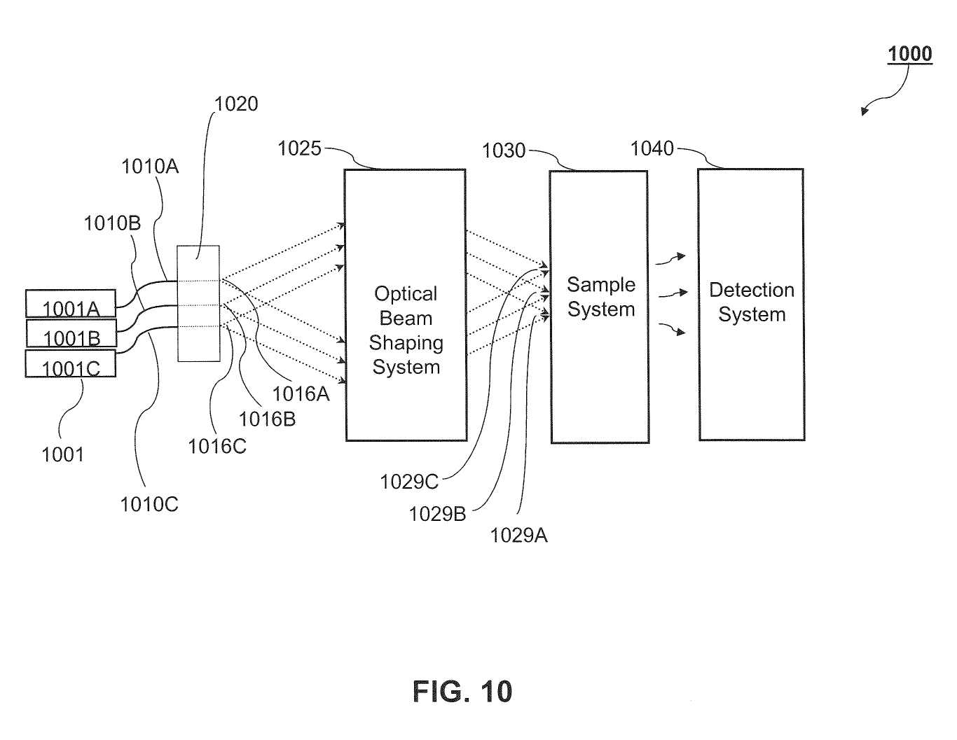

According to an embodiment of the present invention, FIG. 10 illustrates the use of a plurality of fiber optic excitation sources, each of different optical emission wavelength bands, in an array that conditions all of the light sources with a common beam shaping optic to provide tolerance to sample stream position changes at a plurality of optical excitation interrogation points. In the example shown in FIG. 10, system 1000 includes excitation radiation sources 1001A, 1001B, and 1001C, a set of waveguides 1010A, 1010B, and 1010C, a array structure 1020, beam paths 1016 (A, B, and C), 1029 (A, B, and C), an optical beam shaping system 1025, a sample system 1030, and a detection system 1040. A plurality of radiation sources 1001, e.g. 1001A, 1001B, 1001C, etc. can each be coupled to and guided by waveguides 1010A, 1010B, and 1010C, e.g., an optical fiber.

The lasers can be of the same type, emitting radiation in the same wavelength band, but e.g. with different intensities or polarization states, or they can be lasers of different types with different wavelength emission bands.

The distal end of optical fibers 1010, e.g., 1010A, 1010B, 1010C, etc., can be arrayed in an array structure 1020 at the input of optical beam shaping system 1025, such that each radiation source follows a unique path 1016A, 1016B, 1016C through optical beam shaping system 1025, which is common to all of the arrayed fiber optic light sources. Optical beam shaping system 1025 in this example can be carefully designed to provide an optimally achromatic response to the plurality of source light wavelengths that are arrayed in their pathway through the BSO. That is, optical beam shaping system 1025 can create a similar cross section beam shape and a uniform, e.g., flat-top, cross section intensity profile for all of the multiple sources, e.g., 1001A, 1001B, and 1001C, and wavelengths 1010 that transit the system, so that the tolerances to sample particle or sample stream movement in sample system 1030 are high for all of the optical excitation locations 1029C, 1029B, 1029A, etc., generated by optical beam shaping system 1025 and detected by detection system 1040.

In one example, one common beam shaping optic device may not be used to generate the appropriate spatial intensity profiles for all wavelengths of interest. In this example, the fiber-coupled source wavelengths can be segregated and guided into two or more beam shaping devices, each of which can be optimized for a narrower range of specified wavelengths provided to them. It can be noted that this arrangement can somewhat negate the potential benefit of having a compact, common package, multiple-source BSO device.

In a further example of a modification of this embodiment, radiation sources 1001, e.g., lasers, which feed optical fibers 1010A, 1010B, 1010C, etc. that are arrayed before the beam shaping optics 1025, can be mounted in all variety of spatial locations relative to each other, and relative to the cytometer instrument package. This greatly simplifies the mechanical mounting and engineering interface of radiation sources 1001, since all of the sources are brought to a common array point at array structure 1020, by optical fibers 1010, at the beam shaping device. Using multiplexed fiber input devices, several lasers of different wavelengths, powers, polarizations, or any or all of these characteristics can be alternately or jointly coupled into a single fiber and delivered to a single location in the array before the beam shaping optics. An array of these multiplexed inputs can be provided by the spatially separated, multiple fiber outputs, so that a very large number of permutations of light source properties can be generated with a single beam shaping system.

Another example of a variation on this embodiment is the use of fiber optic arrays that are not linear in nature, or not evenly spaced in their elements. For instance, a circularly or rectangularly symmetric array of fibers, or an array with varying locations of focus along the beam shaping system's optical axis, might be desirable to interrogate large samples and characterize their shape or orientations by mapping the spatial sampling point into a correlated detection system, and then forming a two- or three-dimensional plot of fluorescence wavelength, intensity, or scattered intensity as a function of the particle shape or position. It is possible that multiple streams or multiple samples within a single stream can be interrogated simultaneously, or side-by-side positions, by strategic placement and orientation of the various beam shaped optical excitation beams at the sample stream.

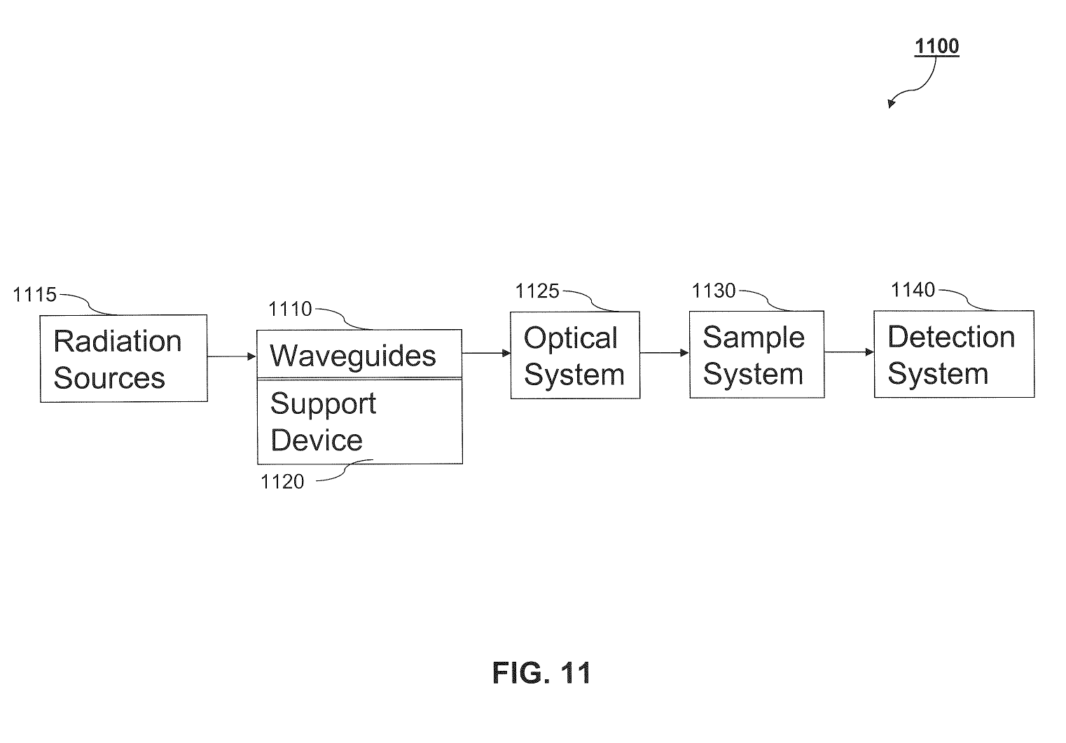

FIG. 11 illustrates a particle analyzer 1100, according to an embodiment of the invention.

In this example, particle analyzer 1100 includes waveguides 1110, one or more radiation sources 1115, a support device 1120, an optical system 1125, a sample system 1130, and detection system 1140.

In one example, waveguides 1110 supported by support device 1120 transmit spatially separated beams of light from source of radiation 1115. In various examples, the source of radiation 1115 can be a singular or a plurality of sources, generating the same or multiple wavelengths and intensities of radiation.

In one example, optical system 1125 (e.g., a beam shaping system) include one or more optical devices, e.g., mirrors, reflective devices, refractive devices, etc. Optical system 1125 can receive spatially separated beams of light from waveguides 1110 and direct the spatially separated beams to focal spots (not shown) along a focal plane (not shown) of a sample flow measuring area (not shown) in sample system 1130 (e.g., a core stream system). Optical system 1125 can also generate a specific irradiation pattern at the focal plane.

In one example, detection system 1140 senses characteristics or parameters of the spatially separated beams, e.g., scatter, fluorescence, etc., after the beams have interacted with particles flowing through the sample flow measuring area.

In an example, the use of multiple waveguides 1110 to transmit radiation to common optical system 1125 allows excitation with a variety of, or a multiplicity of, different wavelengths of radiation without having to position multiple sources of radiation within a confined region around sample system 1130. Waveguides 1110 are positioned in a fixed relative array, which can be less likely to move relative to the beam shaping optics in optical system 1125. This is particularly true if optical system 1125 (e.g., waveguide distal-end array, collimating lenses, beam shaping elements and refocusing elements) is mechanically linked internally and secured together in a way that minimizes the possibility that any one or more elements move relative to the others. Support device 1120 and optical system 1125 can easily align with respect to sample system 1130 as all of the interrogation spots, from multiple sources, move together as one group as the position of the combined element is adjusted relative to a core stream in sample system 1130. Support system 1120 and optical system 1125 can also be relatively compact in physical size, making it easier to integrate into a sample interrogation chamber in a flow cytometer.

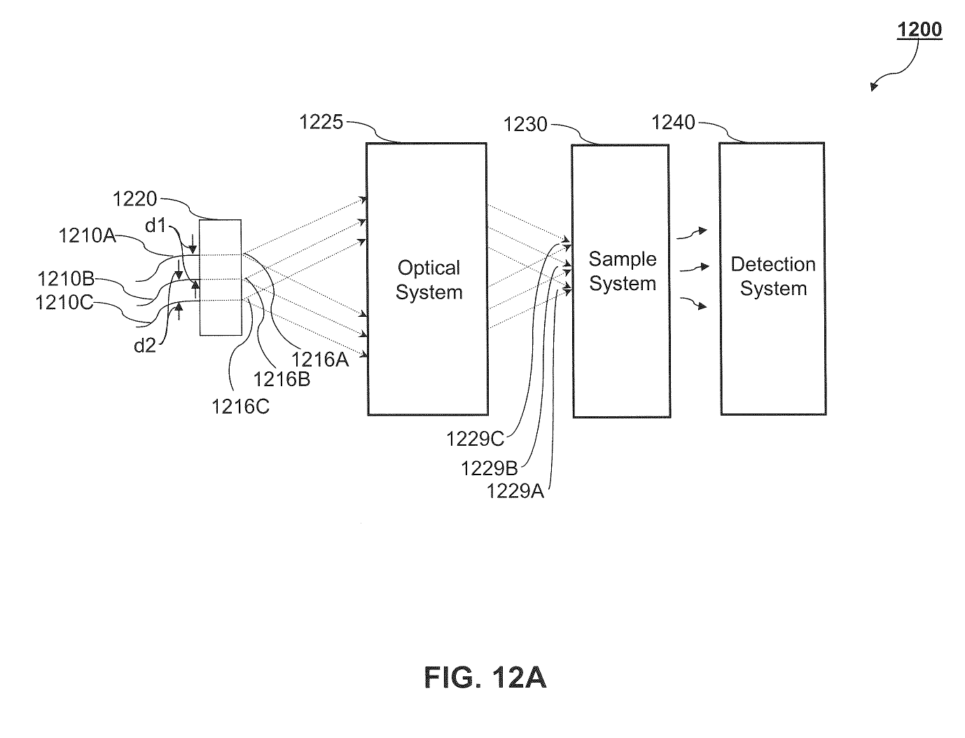

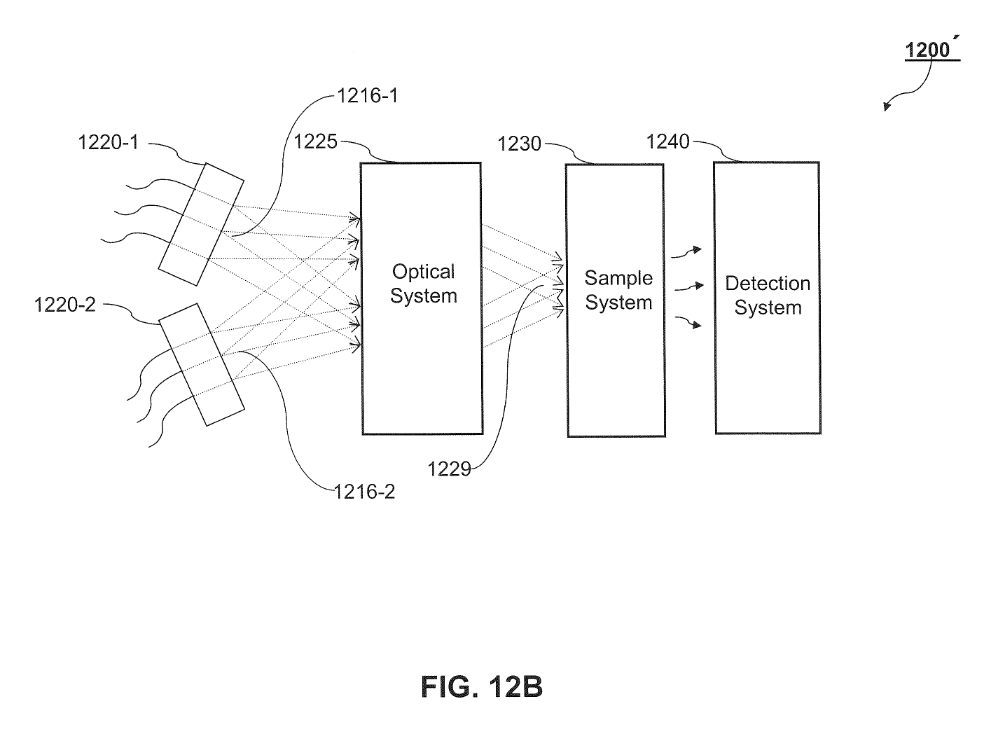

FIG. 12A illustrates a particle analyzer 1200, according to an embodiment of the invention.

In this example, particle analyzer 1200 includes a single waveguide support system 1220 supporting waveguides 1210, an optical system 1225, a sample system 1230, and a detection system 1240.

In one example, single waveguide support system 1220 supports multiple waveguides 1210A, 1210B, and 1210C in a fixed, stable position relative to each other and relative to optical system 1225.

While three waveguides 1210 are shown, fewer or additional waveguides can be supported by waveguide support system 1220 as the number of waveguides required for a specific application can be configured as required for a specific application by a skilled artisan. Waveguides (e.g., 1210A, 1210B and 1210C) receive beams of radiation from one or more sources (not shown). Waveguides 1210 transmit radiation beams 1216A, 1216B, and 1216C to optical system 1225. Waveguide support system 1220 holds waveguides 1210A, 1210B, and 1210C in a fixed position relative to optical system 1225, thereby minimizing optical misalignment.

In one example, optical system 1225 shapes the beams and generates output beams 1229A, 1229B, and 1229C.

Each waveguide (e.g., 1210A, 1210B, and 1210C) can transmit light from a separate source of radiation (not shown). In other embodiments, each waveguide 1210 can transmit light from multiple sources of the same wavelength. In another embodiment, each waveguide 1210 can transmit light of different wavelengths from the same single source of radiation.

In one example, increasing the number of lasers and detectors allows for the detection of multiple labeled antibodies. This approach can more precisely identify a target population, using the antibody binding characteristics.

In one example, waveguide support system 1220 can be configured, such that the waveguides 1210 are held in a substantially stationary manner and aligned so that each waveguide 1210 is substantially parallel to the other waveguides 1210.

In the example shown, waveguide 1210A is separated from waveguide 1210B by a distance of d1, and waveguide 1210B is separated from waveguide 1210C by a distance of d2. The separation distances, d1 and d2, can be of equal values, but are not required to be such. It is understood that the separation distances can be configured according to a specific application.

In another embodiment, optical system 1225 can be configured such that individual beam shaping optics are positioned at the end of each waveguide. In yet another embodiment, optical system 1225 can be fabricated into waveguide support system 1220.

FIG. 12B illustrates a particle analyzer 1200′ (e.g., with dual waveguide supports), according to an embodiment of the invention.

In this example, particle analyzer 1200′ includes waveguide supports 1220-1 and 1220-2 that support waveguides 1210, optical system 1225, sample system 1230, and detection system 1240.

In this example, each waveguide support 1220-1 and 1220-2 is configured with the capability to support multiple waveguides in a similar manner as was shown for single waveguide support system 1220 in FIG. 12A. This configuration allows for transmission of multiple light beams (not shown) from multiple light sources (not shown) to optical system 1225. An output 1216-1 from waveguides supported by support 1220-1 can be combined with output 1216-2 from waveguides supported by waveguide support 1220-2. Output 1216-1 can be at an angle with respect to output 1216-2, or output 1216-1 and 1216-2 can be substantially parallel as dictated by the desired pattern necessary for a particular configuration of a flow cytometer.

In one example, waveguide supports 1220-1 and 1220-2 can be oriented in the same plane, but perpendicular to each other to further assist in allowing waveguides 1210 to generate a desired pattern of output beams 1216-1 and 1216-2. In another embodiment, waveguide supports 1220-1 and 1220-2 can be oriented such that two dimensional, or three-dimensional, mapping of a sample can be performed in conjunction with an imaging or arrayed detector system. In yet another embodiment, waveguide supports 1220-1 and 1220-2 can be configured such that output beams 1216 can be non-linear (e.g., not evenly spaced in their elements). For example, a circularly or rectangularly symmetric array of waveguides 1210, or an array with varying locations of focus along an optical axis of optical system 1225, can be desirable to interrogate large samples. Such interrogation can characterize a shape or orientation by mapping the spatial sampling point into a correlated detection system, and forming a fluorescence wavelength, intensity, or scattered intensity two- or three-dimensional plot. It is possible that multiple streams or multiple samples within a single stream can be interrogated simultaneously or side-by-side by strategic position and orientation of the various beam shaped light spots at the sample interrogation chamber.

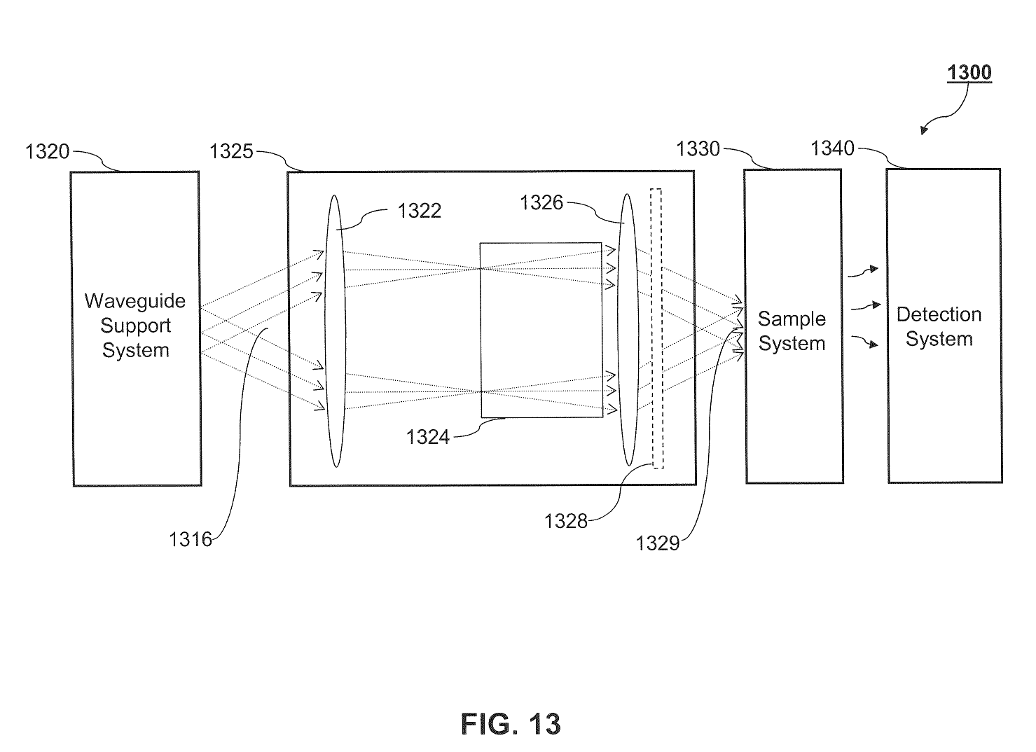

FIG. 13 illustrates a particle analyzer 1300, according to an embodiment of the invention.

In this example, particle analyzer 1300 includes a waveguide support system 1320, an optical system 1325, a sample system 1330, and a detection system 1340.

In one example, waveguides (not shown) held by waveguide support system 1320 transmit naturally diverging light from a source of radiation (not shown) to generate one or more input beams 1316. Input beams 1316 are transmitted to optical system 1325.

In one example, optical system 1325 can include one or more optical elements that shape input beams 1316 into a desired configuration to produce output beams 1329. Output beams 1329 are transmitted to focus within sample system 1330. For example, optical system 1325 can include one or more of a collimating lens 1322, a beam shaping optic 1324 (e.g., a Powell lens), a focusing lens 1326 (e.g., a tertiary lens), and an optional protective lens 1328. It is to be appreciated that the optical elements can be manufactured from various materials (e.g., glass, transparent polymers, or polycrystalline or crystalline material) that allow an acceptable level of transmission, which is based on a desired wavelength of light to be used in the system.

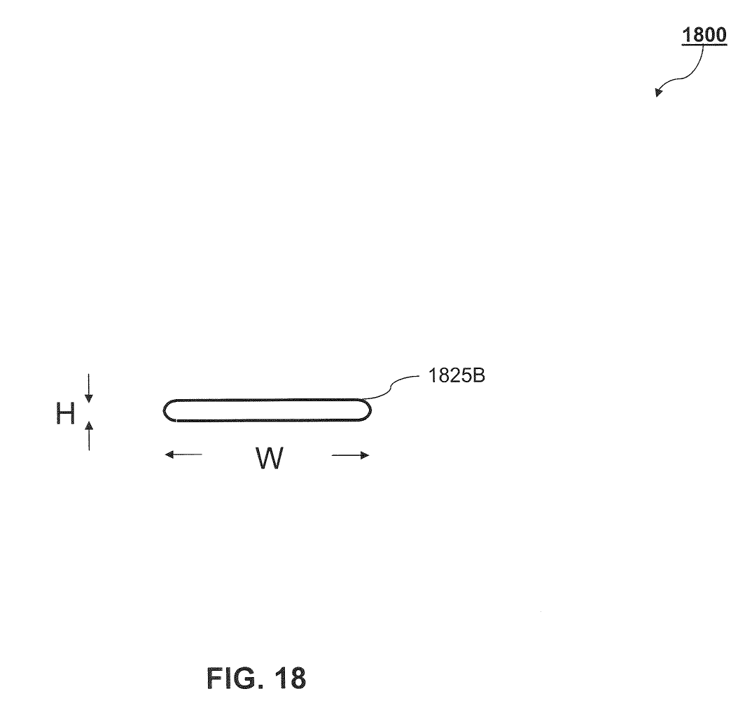

As is known to a skilled artisan, beam shaping optic 1324, such as a Powell lens, produces a high aspect ratio, linear or rectangular-like spatial intensity profile. This profile, which can be referred to as a line focus, provides a uniform irradiance along the long axis of the line-focused light pattern (e.g., flat-top profile), and will be further discussed in FIG. 18.

In this example, optical system 1325 can be used to focus the flat-top profiled light beam onto a core stream (not shown). For example, it is desirable that the horizontal length of the light spot is sufficiently wide enough to provide uniform illumination to the core stream in sample system 1330. In addition, focusing lens 1326 can provide a low sensitivity to optical, mechanical, and fluidic positional variations in regards to a flow cytometer fluorescence signal.

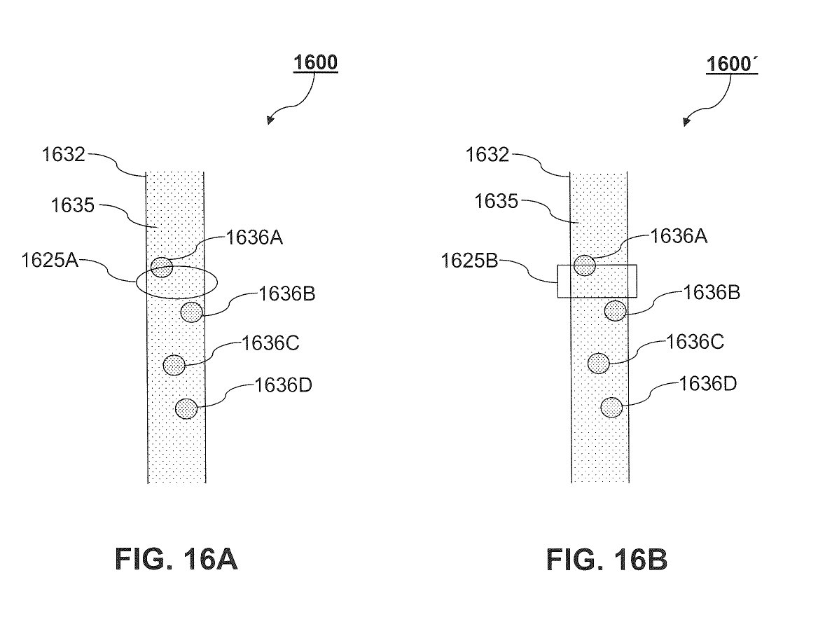

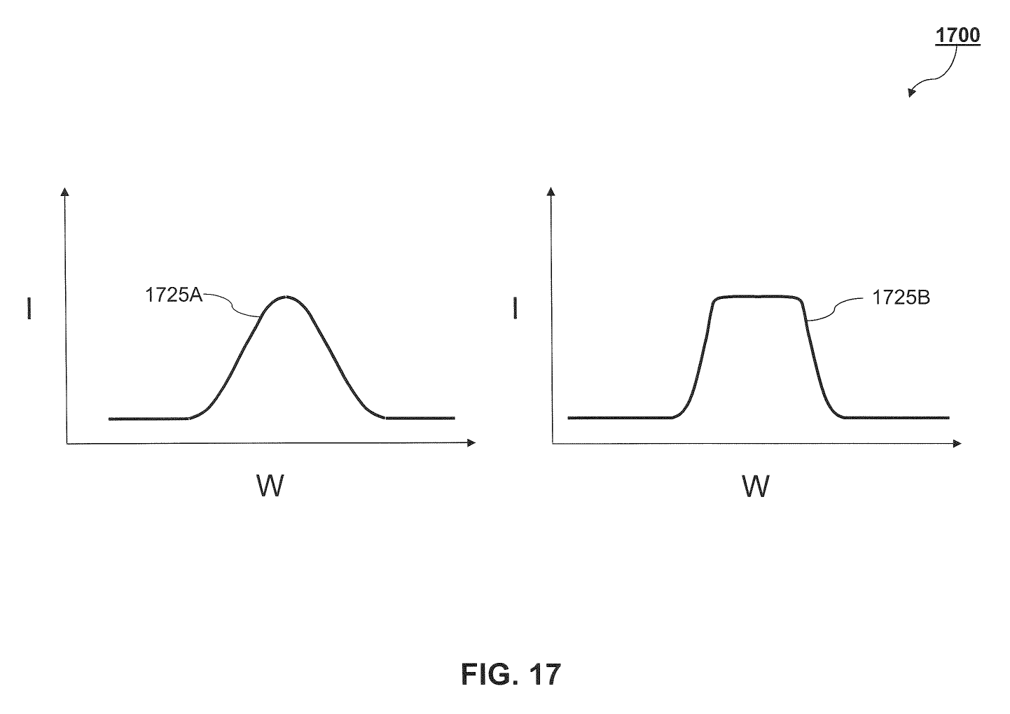

In one example, without a uniform, e.g., flat-top, intensity profile only 20% to 30% of the laser energy is utilized to interrogate particles within a core stream. The low efficiency can require higher powered radiation sources. High powered radiation sources can result in higher energy dissipation, associated lower throughput, and less efficient utilization. The high aspect ratio beam shape with a flat-top intensity profile provides a good temporal resolution to a measurement of sample traveling across the narrow axis, discussed in more detail below with regards to FIGS. 16A-17. In certain examples, a majority, or even greater than 80%, of radiation energy can be concentrated on interrogating particles within a flow stream in sample system 1330.

In one example, optional protective lens 1328 can be inserted in optical system 1325 in order to protect the system from any contamination from outside of optical system 1325 (e.g., from the core stream). Protective lens 1328 can be configured to have further optical properties as known to one skilled in the art. Optional protective lens 1328 is manufactured from material appropriate to the desired effect of the protective lens (e.g., heat, radiation, corrosive material, etc.).

Additionally, or alternatively, optical system 1325 can include additional positive or negative optics, anamorphic telescopes, astigmatic focusing systems, prism-based system, or other techniques, which can be used as required to further shape input beams 1316 as known to one skilled in the art.

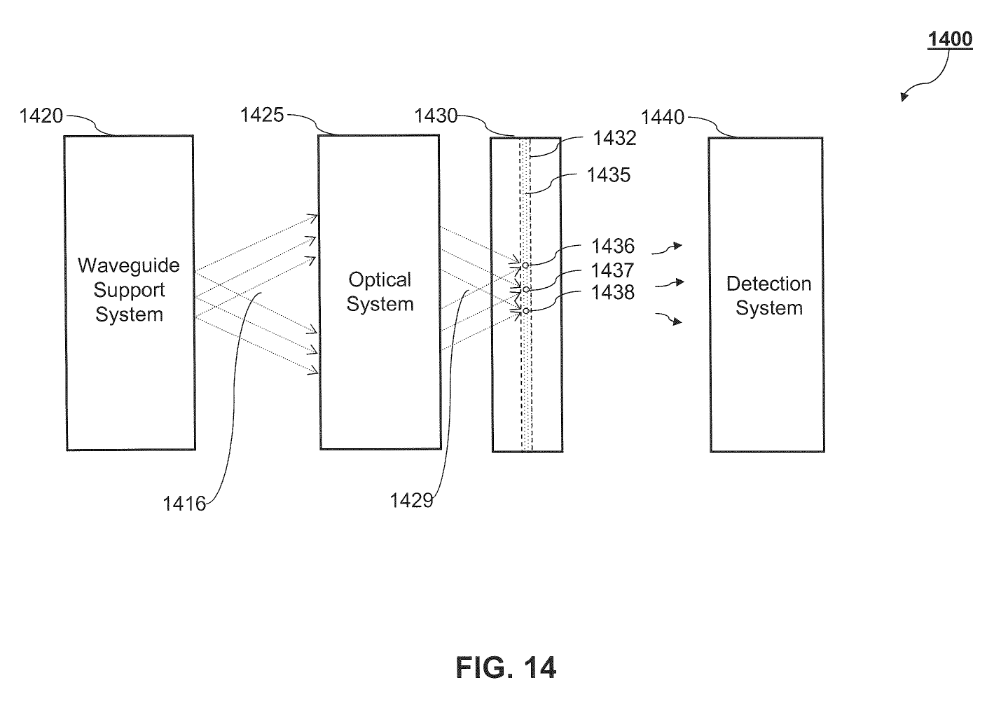

FIG. 14 illustrates a particle analyzer 1400, according to an embodiment of the invention.

In this example, particle analyzer 1400 includes a support system 1420, an optical system 1425, a sample system 1430, and a detection system 1440. Optical system 1425 receives input beams 1416 from waveguides (not shown) supported by support system 1420 and produces output beams 1429 therefrom.

In one example, output beams 1429 produced by optical system 1425 are focused onto a sample area 1435 of a core stream. In one example, the core stream can be enclosed within a containment structure 1432. In another embodiment, the core stream can travel through a medium (e.g., air or another liquid, gas, fluid, etc.), with no solid containment structure.

In one example, support system 1420 allows the waveguides to transmit input beams 1416 from one or more radiation sources (not shown), such that a beam from each radiation source follows a unique path through optical system 1425. Any spatial offset between input beams 1416 can be maintained with respect to output beams 1429 and the corresponding focused spots from each of the output beams 1429 at measuring area 1435. In this example, three focal spots, shown as focal spots 1436, 1437, and 1438, represent where three output beams 1429 are focused in sample area 1435. In one example, spatial offsets between the focal spots, i.e., between focal spots 1436 and 1437, are proportional to the distance between the spatial offset of input beams 1416 traveling from the waveguides, as was previously discussed in FIG. 12A, i.e., the spatial offset between waveguides 1210A, 1210B, and 1210C. While three focal spots are shown, more or fewer focus spots can be formed on sample area 1435, as can be understood by a skilled artisan. In addition, while focal spots 1436, 1437 and 1438 are shown as being distributed along the axis of sample area 1435, such focus spots can also be distributed orthogonally across sample area 1435, or in any other arrangement.

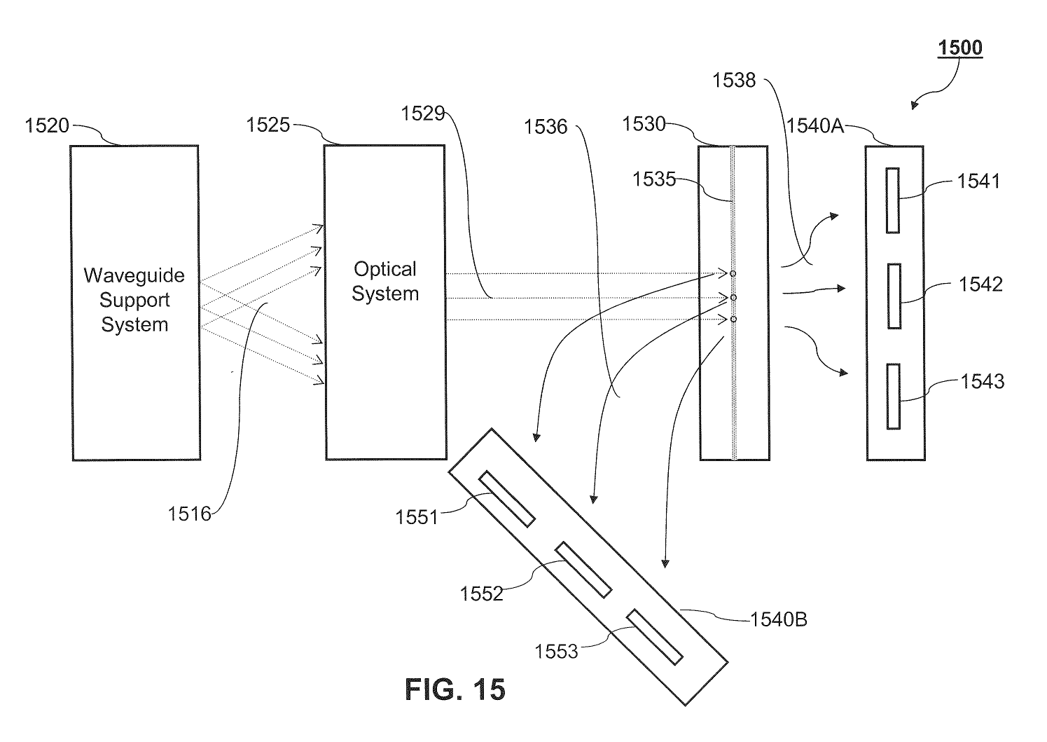

FIG. 15 illustrates a particle analyzer 1500, according to an embodiment of the invention.

In this example, particle analyzer 1500 includes a waveguide support system 1520, an optical system 1525, a sample system 1530, and a detection system 1540, which includes detection systems 1540A and 1540B.

In one example, waveguide support system 1520 supports waveguides (not shown) that direct input beams 1516 from one or more sources of radiation (not shown) to optical system 1525. Optical system 1525 produces output beams 1529. Optical system 1525 directs output beams 1529 to sample system 1530. Output beams 1529 are directed to a focal plane of a measurement region 1535 of a core stream to interact with particles within the core stream. The core stream can be a fluid sample in sample system 1530. Interacting with the particles can generate generally forward-traveling, transmissive scattering or fluorescence signals 1538 and/or generally oblique angled fluorescence and/or scattered or reflective signals 1536. Signals 1536 and 1538 can correspond to one or more events detected in a sub-sample of the fluid sample, (e.g., the core stream), flowing through the measurement region 1535 in sample system 1530. Such signals can be analyzed by an analyzer (not shown) in order to determine a parameter of a particle.

In one example, detectors 1540A and 1540B are positioned to receive signals from a point where the core stream passes through output beams 1529. Detectors 1540A in line with output beams 1529 will detect Forward Scatter (FSC). Detectors 1540B are positioned at an angle or perpendicular to output beams 1529 to detect Side Scatter (SSC) and fluorescence. Each particle, e.g., sized from about 0.2 to 150 micrometers, that passes through output beams 1529 will scatter the light in some way, and fluorescent chemicals found in the particle or attached to the particle can be excited into emitting light at a different wavelength than the light source. This combination of scattered and fluorescent light is received by the detectors, and by analyzing fluctuations in brightness at each detector (one for each fluorescent emission peak), it is then possible to derive information about the physical and chemical nature of each individual particle.

In one example, transmissive scatter signals 1538 are sensed by detection system 1540A. In a similar manner, in one example, some combination of fluorescent or reflective scatter signals 1536 are sensed by detection system 1540B.

In one example, detection system 1540A includes multiple sensors 1541, 1542, and 1543, while detection system 1540B includes multiple sensors 1551, 1552, and 1553. However, more or fewer sensors can be included in detection systems 1540A and/or 1540B. In one example, detection systems 1540A and/or 1540B can be configured and positioned in any position within the three-dimensional area surrounding sample system 1530. For example, detection systems 1540A and/or 1540B can be positioned at different distances from sample system 1530, as well as at different relative positions along the axis of core stream 1535.

FIG. 16A illustrates a portion of a particle analyzer 1600, according to an embodiment of the invention.

In this example, the portion of a particle analyzer 1600 includes an optional containment device 1632, a sample area 1635 though which a core stream can flow, and particles 1636.

Particles 1636 travel in the core stream and pass through an elliptical beam 1625A. Particles 1636 scatter or emit light based on their interaction or interrogation from elliptical beam 1625A, as previously discussed. Particles 1636 are positioned within the core stream in a variety of places, some near the edge of the core stream and some near the center of the core stream. As elliptical beam 1625A is elliptical in shape, the output power of the beam is not consistent across the width of the beam. The center will contain a higher amount of power, and hence cause greater interaction with particles 1636 versus where particles are close to the edge of the core stream, e.g., sample cell 1636B, as it passes through the edge of elliptical beam 1625A. Such variations will produce an amount of inconsistency in the interaction of elliptical beam 1625A and particles 1636.

FIG. 16B illustrates a portion of a particle analyzer 1600′, according to an embodiment of the invention.

In this example, sample system 1600′ contains an optional containment device 1632, a measuring area 1635 through which can flow a core stream, and particles 1636.

Similar to FIG. 16A, particles 1636 travel in the core stream, but they now travel through flat-top beam 1625B causing particles 1636 to scatter or emit energy. Particles 1636 are positioned within the core stream in a variety of places, some near the edge of the core stream and some near the center of the core stream. However, the flat-top focused shape of beam 1625B provides a high aspect ratio beam shape, with a flat-top intensity profile in at least the long axis, and possibly in the narrow axis of the focus spot of the beam on the particles. This flat-topped focal pattern, which is sometimes referred to as a line focus, is created from each of the input waveguides (not shown) as a focused spot, such as 1625B a singular, common optical system (not shown).

In one example, the flat-top profiled light beam size is created such that the vertical height of the beam can be less than 10 micrometers, and the horizontal length of the light spot is sufficiently wide enough, e.g., up to 100 micrometers, to provide uniform illumination to the core stream, e.g., where the width of the core stream is less than 100 micrometers, even if some variation occurs between the relative position of the interrogating light beam and the sample stream under measurement. This high aspect ratio beam shape, with a uniformly flat-top intensity profile, provides good temporal resolution to the measurement of sample traveling across the narrow axis, and low sensitivity of the flow cytometer fluorescence signal to optical, mechanical, and fluidic positional variations. Generally, the width of the flat-top beam is greater than the predicted or theoretical width of the core stream. The vertical height of the flat-top beam is generally 50% or less than the width of the beam. In other embodiments, the vertical height is less than 25% of the width of the beam and in other embodiments it is 10% or less than the width of the beam.

FIG. 17 illustrates two dimensional beam graphs 1700, according to an embodiment of the invention.

In this example, beam graph 1700 includes an elliptical beam graph 1725A and a flat-top beam graph 1725B.

In an example, elliptical beam graph 1725A plots intensity of the beam as a function of the width of the beam. Elliptical beam graph 1725A illustrates a peak intensity at the center of the beam, which decreases immediately off center. In contrast, flat-top beam graph 1725B maintains a more consistent delivery of intensity across the width of the beam. As discussed in FIG. 16B, a more consistent beam intensity across the width of the beam yields more consistent particle interaction results.

FIG. 18 illustrates a flat-top focused beam 1800, according to an embodiment of the invention.

In this example, flat-top focused beam 1825B illustrates the relative width, e.g., W, and height, e.g., H, of the beam. For example, the height “H” of the beam can be approximately 3 to 10 micrometers. In another example, the width “W” of the beam can be approximately 40 to 100 micrometers.

It is to be appreciated that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention cannot be limited by any of the above-described exemplary embodiments, but can be defined only in accordance with the following claims and their equivalents.

What is claimed is:

1. A particle analyzer, comprising:
optical waveguides configured to direct spatially separated beams from a source of radiation to produce measuring beams in a sample flow measuring area;
a support configured to maintain each of the optical waveguides in a fixed relative position with respect to each other and maintain positioning of the measuring beams within the measuring area; and
a detector configured to sense light produced from the measuring beams interacting with a particle flowing through the measuring area.

2. The particle analyzer of claim 1, wherein the measuring beams comprise substantially uniform spatial intensity profiles or flat-top profiles.

3. The particle analyzer of claim 1, wherein the optical waveguides comprise fiber optics.

4. The particle analyzer of claim 1, wherein the source of radiation comprises a plurality of laser sources.

5. The particle analyzer of claim 4, wherein the plurality of laser sources produce a plurality of different wavelengths, wavelength bands, polarizations, or pulse widths of light.

6. The particle analyzer of claim 1, wherein the sample flow measuring area is contained within a sample system comprising a cuvette or an air space.

7. The particle analyzer of claim 6, wherein at least one of the support and the detector is coupled to the core stream sample system.

8. The particle analyzer of claim 7, wherein the coupling comprises the use of optical waveguides device configured to convey optical radiation arising from sample interaction to the detector.

9. The particle analyzer of claim 1, wherein the source of radiation produces a plurality of wavelengths, wavelength bands, polarizations, or pulse widths of light.

10. The particle analyzer of claim 1, wherein the detector comprises a plurality of detectors corresponding to various detector positions surrounding the sample flow measuring area.

11. The particle analyzer of claim 1, wherein the support comprises substantially parallel grooves funned in a one or more dimensional array.

12. The particle analyzer of claim 1, further comprising:
a cover plate coupled to the support device and configured to constrain three-dimensional movement of the optical waveguides.

13. The particle analyzer of claim 12, wherein the cover plate is configured to constrain a longitudinal translation of a terminal end of the optical waveguides.

14. The particle analyzer of claim 1, further comprising:
an optical system configured to direct the spatially separated beams from the optical waveguide to the measuring spots.

15. The particle analyzer of claim 14, wherein the optical system and the support system are fixedly mechanically linked to minimize relative movement.

16. A method of analyzing particles, comprising:
preparing a fluid sample containing particles for analysis in a particle analyzer;
transmitting light from a source of radiation through optical waveguides;
directing the light from the optical waveguides as a plurality of spatially separated beams along a plane of a measurement region of the fluid sample;
sensing light produced through the interaction of the spatially separated beams with respective particles flowing through the measurement region; and
analyzing the signals to determine a parameter of the respective particles.

17. The method of claim 16, further comprising producing a substantially uniform spatial intensity profile in a portion of the beam directed along the plane of the measurement region.

18. A system comprising:
a fiber optic bundle configured to receive beams from respective radiation sources and to produce serial spatially separated substantially uniform spatial intensity profile beams in a measurement area;
a V-groove support system including an array of V-grooves, each of the V-grooves configured to individually support a corresponding fiber in the fiber optic bundle and to maintain a fixed relative spacing between the fibers and the serially separated beams; and
a particle detector configured to sense light reflected, scattered or emitted by particles based interrogation from the beams,
wherein the serial spatially separated beams are directed onto the particles using a beam shaping optical system.

19. The system of claim 18, wherein the spatially separated beams comprise a substantially uniform spatial intensity profile in a portion of the beam in the measurement area.

20. A particle analyzer, comprising:
a first optical system configured to be fixedly coupled to a sample system and configured to direct beams along independent beam paths from a source of radiation to produce measuring beam spots in a sample flow measuring area of the sample system; and
a detection system configured to sense radiation delivered from the sample flow measuring area.

21. The particle analyzer of claim 20, wherein the first optical system is adhered to the sample system using an adhering material.

22. The particle analyzer of claim 20, wherein the first optical system is mechanically fastened to the sample system.

23. The particle analyzer of claim 20, wherein the detection system is fixedly coupled to the sample system.

24. The particle analyzer of claim 20, wherein the measuring beam spots comprise a substantially uniform spatial intensity profile in a portion of the spots in the measurement area.
